(19) United States
(12) Patent Application Publication
(10) Pub. No.: US 2024/0330590 A1
(43) Pub. Date: Oct. 3, 2024

(54) DISTRIBUTED SPOKEN LANGUAGE INTERFACE FOR CONTROL OF APPARATUSES

(71) Applicant: Analog Devices, Inc., Wilmington, MA (US)

(72) Inventors: Jonathan Samuel YEDIDIA, Cambridge, MA (US); Nicholas Eastman MORAN, Cambridge, MA (US)

(21) Appl. No.: 18/404,666

(22) Filed: Jan. 4, 2024

Related U.S. Application Data
(60) Provisional application No. 63/456,296, filed on Mar. 31, 2023.

(51) Int. Cl. G06F 40/289

(52) U.S. Cl. CPC G06F 40/289

(57) ABSTRACT

Technologies are provided for a distributed spoken language interface for speech control of multiple apparatuses. In some aspects, a first apparatus can receive an audio signal representative of speech. The first apparatus can detect, based on applying a keyphrase recognition model to the speech, a keyphrase. The keyphrase can include a first string of characters defining an identifier corresponding to at least one second apparatus and also includes a second string of characters defining a command. The first apparatus can cause, based on the identifier, a communication unit integrated in the first apparatus to send the keyphrase to the at least one second apparatus. The at least one second apparatus can receive the keyphrase, and can cause one or more components to execute the command.

### CROSS-REFERENCE TO RELATED APPLICATIONS

This patent application claims the benefit of and priority to U.S. Provisional Patent Application No. 63/456,296, filed Mar. 31, 2023. The contents of which application are hereby incorporated herein by reference in their entireties.

### BACKGROUND

Existing keyphrase recognition systems are typically based on machine-learning (ML) techniques. Such systems are generated by collecting a substantial amount of data of people with different accents speaking the keyphrase, and then training a machine-learning model, such as a neural network, to provide a recognition when the keyphrase is spoken. Generating a keyphrase recognition system in such a fashion is intensive in terms of both computing resources and human resources. As a result, generating a new keyphrase recognition system or modifying an existing one by adding new keyphrases tends to be burdensome.

Keyphrase detection can be used to control, using speech, one or more apparatuses, either remotely or locally. Local control of apparatuses with spoken commands, however, can be difficult due to noise generated by the apparatuses. For example, controlling a mobile robot with a spoken command may be difficult when the mobile robot generates considerable noise while moving. Similarly, as another example, controlling an industrial trash compactor with a spoken command may be difficult when the compactor is in operation and generates considerable noise.

Therefore, much remains to be improved in technologies for the generation of keyphrase recognition systems and their application to practical problems such as control of apparatuses with spoken commands.

### SUMMARY

In an aspect, a method for controlling, using speech, multiple apparatuses. The method includes receiving, by a first apparatus, an audio signal representative of speech; detecting, by the first apparatus, based on applying a keyphrase recognition model to the speech, a keyphrase, wherein the keyphrase comprises a first string of characters defining an identifier corresponding to at least one second apparatus and further comprises a second string of characters defining a command; and causing, based on the identifier, the first apparatus to send the keyphrase to the at least one second apparatus.

Another aspect includes a system comprising multiple apparatuses, each comprising an audio input device, a keyphrase detection module, and a communication unit. A first apparatus of the multiple apparatus is configured to receive, via the audio input device, an audio signal representative of speech; detect, via the keyphrase detection module, based on applying a keyphrase recognition model to the speech, a keyphrase, wherein the keyphrase comprises a first string of characters defining an identifier corresponding to at least one second apparatus of the multiple apparatuses and further comprises a second string of characters defining a command; and cause, based on the identifier, the communication unit to send the keyphrase wirelessly to the at least one second apparatus.

An additional aspect includes an apparatus comprising at least one processor, and at least one memory devices storing processor-executable instructions that, in response to being executed by the at least one processor, cause the apparatus to: receive an audio signal representative of speech; detect, based on applying a keyphrase recognition model to the speech, a keyphrase, wherein the keyphrase recognition model is based on multiple keyphrases, and wherein the keyphrase comprises a first string of characters defining an identifier corresponding to at least one second apparatus, and further wherein the keyphrase comprises a second string of characters defining a command; and cause, based on the identifier, a communication unit integrated into the apparatus to send the keyphrase to the at least one second apparatus.

A further aspect includes a computer-readable medium having instructions stored thereon, where the instructions are executable by at least one processor, individually or in combination, to perform the above-noted method.

### BRIEF DESCRIPTION OF THE DRAWINGS

The accompanying drawings form part of the disclosure and are incorporated into the subject specification. The drawings illustrate example aspects of the disclosure and, in conjunction with the following detailed description, serve to explain at least in part various principles, features, or aspects of the disclosure. Some aspects of the disclosure are described more fully below with reference to the accompanying drawings. However, various aspects of the disclosure can be implemented in many different forms and should not be construed as limited to the implementations set forth herein. Like numbers refer to like elements throughout.

FIG. 1A is a block diagram of an example of a computing system for keyphrase detection, in accordance with one or more aspects of this disclosure.

FIG. 1B is an example of a listing of keyphrases for a system of multiple apparatuses, in accordance with one or more aspects of this disclosure.

FIG. 2 is a block diagram of an example of a computing system for keyphrase detection, in accordance with one or more aspects of this disclosure.

FIG. 3A is a listing of a recognition output over time for an example of partial and final recognitions, in accordance with one or more aspects of this disclosure.

FIG. 3B is a listing of a recognition output over time for another example of partial and final recognitions, in accordance with one or more aspects of this disclosure.

FIG. 4A is a block diagram of an example of a computing system for keyphrase detection, in accordance with one or more aspects of this disclosure.

FIG. 4B is a block diagram of an example of a system of devices that can provide various functionalities of keyphrase detection and execution of control operation(s), in accordance with one or more aspects of this disclosure.

FIG. 5A is a block diagram of an example of a system that uses a distributed spoken language interface, in accordance with one or more aspects of this disclosure.

FIG. 5B is a block diagram of another example of a system that uses a distributed spoken language interface for voice control, in accordance with one or more aspects of this disclosure.

FIG. 6 is a block diagram of an example of an apparatus that can be part of a system using a distributed spoken language interface, in accordance with one or more aspects of this disclosure.

FIG. 7 is a block diagram of an example of a system that uses a distributed spoken language interface, in accordance with one or more aspects of this disclosure.

FIG. 8 is a flowchart of an example of a method for detecting keyphrases, in accordance with one or more aspects of this disclosure.

FIG. 9 is a flowchart of an example of a method for generating a language model, in accordance with one or more aspects of this disclosure.

FIG. 10 is a flowchart of an example of a method for detecting a keyphrase, in accordance with one or more aspects of this disclosure.

FIG. 11 is a flowchart of an example of a method for controlling, using speech, the operation of an apparatus in a system having a distributed spoken language interface, in accordance with one or more aspects of this disclosure.

### DETAILED DESCRIPTION

The present disclosure recognizes and addresses, among other technical challenges, the issue of keyphrase detection in the interaction with computing devices. Reliable detection of spoken keyphrases can permit using speech to interact with computing devices or other types of apparatuses having computing resources. Keyphrases can be phrases that cause a computing device or apparatus to be energized (e.g., “start cleaning” or “hey analog”) or to power off (e.g., “shut down”). Keyphrases also can be phrases that cause the computing device or apparatus to execute a task (e.g., “turn on the lights,” “lock patio doors,” or “compact trash”). Further, existing technologies to reliably communicate using speech with noisy robots or other types of noisy apparatuses are scarce because it is difficult to address the poor signal-to-noise ratio issues present when attempting to control, using speech, the robots or other apparatuses. Indeed, it is commonplace to use robotic control systems that involved joysticks or other types of manual control systems rather than using speech. Even in situations when speech is used to control robots or other types of apparatuses, such voice control is typically implemented in environment having low levels of ambient noise or when the robots or other apparatuses are not generating noise.

The present disclosure further recognizes and addresses, among other technical challenges the issue of controlling operation of machines using voice commands in an environment having high levels of ambient noise. Aspects of the present disclosure enable the reliable control, via spoken language, of one or more robots and/or other machines that may generate considerable noise (e.g., noise having an intensity of 80 dB or greater) in their operation.

As is described in greater detail below, aspects of this disclosure can configure a keyphrase recognition model based on multiple keyphrases, and can then apply the configured keyphrase recognition model to detect one or several of the multiple keyphrases in speech in a natural language. Aspects of this disclosure can configure the keyphrase recognition model by generating, using the multiple keyphrases, a domain-specific language model that is then combined with a wide-vocabulary language model that is based on an ordinary spoken natural language. The configuration of the keyphrase recognition model can be readily modified by updating data defining the multiple keyphrases and generating an updated keyphrase recognition model. Additionally, configuration of the keyphrase recognition model is dramatically less time intensive than configuration of existing keyphrase detection technologies. Indeed, configuration of the keyphrase recognition models of this disclosure can be accomplished as easily as compiling a new version of a computer program.

After a keyphrase recognition model has been configured, aspects of the disclosure can detect one or several particular keyphrases by applying the configured keyphrase recognition model to speech. Detection can use automated speech recognition (ASR) to identify a sequence of words present in the speech, and can analyze a suffix of such a sequence to determine if a particular keyphrase is present in the speech. Presence of the particular keyphrase yields a recognition of the particular keyphrase. In some cases, an initial recognition of the particular keyphrase results in the detection of the particular keyphrase. In other cases, the recognition of the particular keyphrase can be deemed preliminary, and additional recognition of the particular keyphrase after a latency time period during which additional speech may be received can confirm that the particular keyphrase has been recognized. Such confirmation results in the detection of the particular keyphrase. The latency time period is configurable and can be specific to the particular keyphrase.

The keyphrase recognition model can be integrated into each apparatus in a group of multiple apparatuses. To that end, each apparatus can include a detection module that is functionally coupled with an audio input unit, and the keyphrase recognition model can be integrated into the detection module. The detection module configured with the keyphrase recognition model in combination with the audio input unit can form an interface for the processing of spoken language. Such an interface can thus be referred to as a spoken language interface. In this way, a distributed spoken language interface can be formed in the group of multiple apparatuses.

The distributed spoken language interface can permit detecting, in each apparatus in the group, one or several keyphrases by applying the keyphrase recognition language to speech. A detected keyphrase can correspond to the apparatus that detected the keyphrase. Hence, the apparatus can respond to the detected keyphrase. For example, as is described herein, the apparatus can execute one or more operation in response to a command defined by the detected keyphrase. In addition, or in other cases, one or more apparatuses can detect one or more keyphrases corresponding to one or more other apparatuses within the group. Each apparatus can then communicate the detected keyphrase(s) to the one or more other apparatuses. The detected keyphrase(s) can be communicated wirelessly in numerous ways. In some cases, an apparatus can unicast a particular keyphrase of the detected keyphrase(s) to another apparatus in the group, where the particular keyphrase corresponds to that other apparatus. In other cases, the apparatus can multicast a particular keyphrase of the detected keyphrase(s) to specific apparatus(es) that are a defined type of apparatus within the group. The particular keyphrase corresponds to the select apparatus(es). In yet other cases, an apparatus can broadcast the detected keyphrase(s) to other apparatus(es) that form the group.

As mentioned, keyphrases can define respective commands for a particular apparatus. Regardless of how the particular apparatus receives a keyphrase from another apparatus, the particular apparatus can execute an operation in response to the command defined by the keyphrase. Because more than one apparatus in the group of apparatuses can communicate the keyphrase to the particular apparatus, the reliability of voice control in accordance with aspects of this disclosure can be superior to existing technologies for voice control.

In sharp contrast to commonplace technologies, aspects of this disclosure avoid using machine-learning techniques, and provide a computationally efficient approach that can reduce the use of computing resources, such as but not limited to a compute time, memory storage, network bandwidth, and/or similar resource. Indeed, techniques, devices, and systems of this disclosure can implement keyphrase detection that is performed in the presence of noise and/or or in cases where the speaker has accented speech. Such techniques, devices, and systems can be operational even in the absence of network connectivity. Besides computational efficiency and versatility, the techniques, devices, and systems of this disclosure can provide improved keyphrase detection performance over existing technologies.

Further, because more than one apparatus in a system of apparatuses can communicate a detected keyphrase to a particular apparatus, the reliability of speech control in accordance with aspects of this disclosure can be superior to existing technologies for voice control. Additionally, the air interface used to communicate the keyphrase is unaffected by sound attenuation. Accordingly, not only can the particular apparatus be controlled using spoken commands, but the particular apparatus need not operate in a quiet environment.

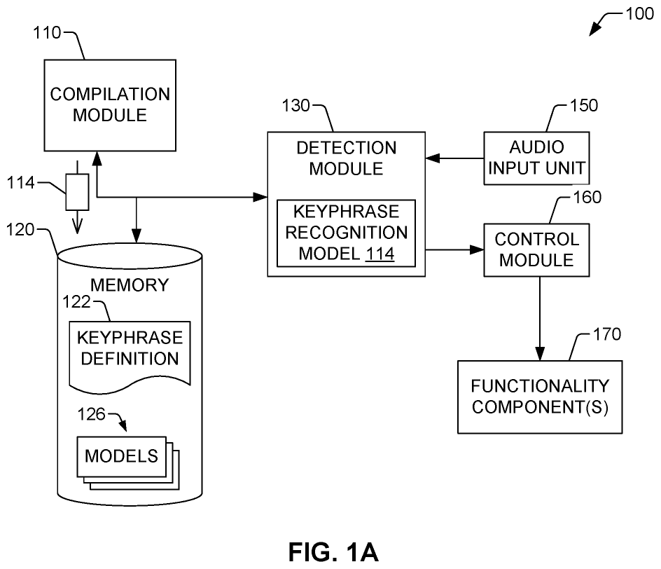

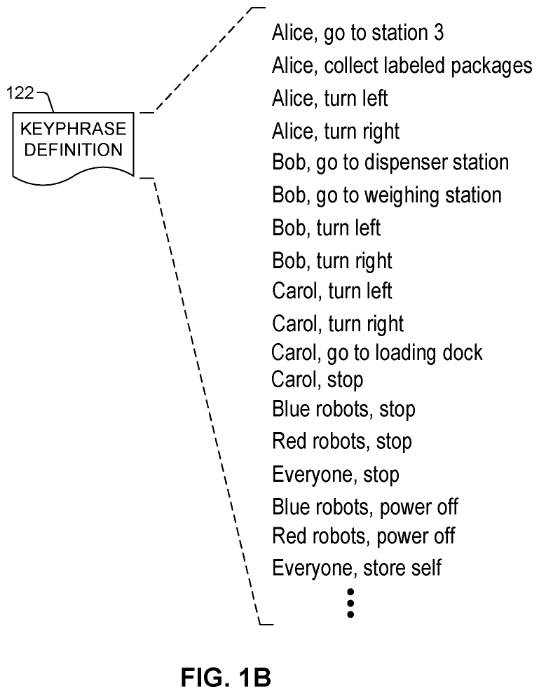

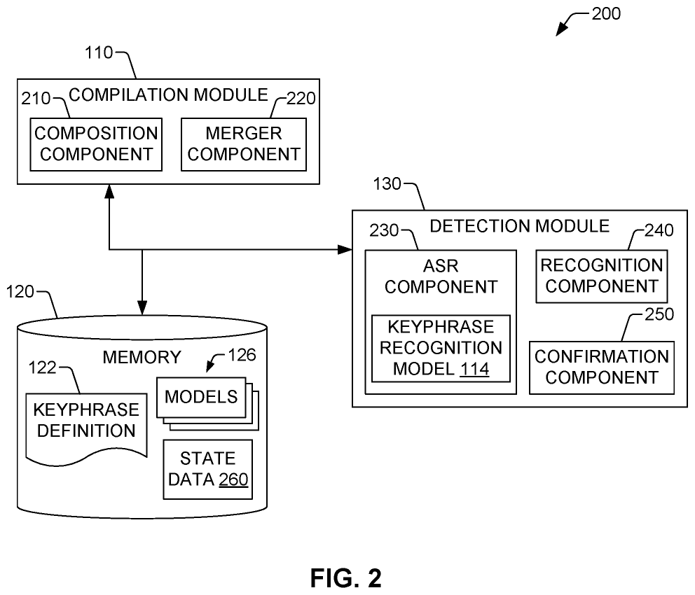

FIG. 1A illustrates an example of a computing system 100 for keyphrase detection, in accordance with one or more aspects of this disclosure. The computing system 100 can include a compilation module 110 that can generate a domain-specific language model based on multiple keyphrases in a natural language (such as, but not limited to, English, German, Spanish, or Portuguese). The domain-specific language model can be a statistical n-gram model. The multiple keyphrases define a language domain where each legal sentence in the language domain corresponds to a respective one of multiple keyphrases. That is, as used herein, a legal sentence is a statement that includes a group of words, a phrase, or a sentence that represents a keyphrase to be recognized. The compilation module 110 can generate probabilities of words in the domain (the unigrams), along with the probabilities that one word follows another word (bi-grams), and continuing up to probabilities that a word follows a sequence of n−1 other words (n-grams). In one example scenario, the multiple keyphrases can consist of two keyphrases: “hello analog” and “open the windows,” each defining a legal sentence. Considering that each of those two legal sentences are equally likely, the compilation module 110 can generate a set of unigrams for each of the words “hello,” “analog,” “open,” “the,” and “windows,” along with bigrams having non-zero probabilities for “analog” if it follows “hello”, and “the” if it follows “open,” and “windows” if it follows “the,” and a trigram probability for “windows” if it follows “open” and “the” in that order. In some aspects, as is illustrated in the computing system 200 in FIG. 2, the compilation module 110 can include a composition component 210 that can generate the domain-specific language model.

To generate the domain-specific language model, the compilation module 110 can access multiple keyphrases. Accessing the multiple keyphrases can include reading a document 122 (which can be referred to as keyphrase definition 122) retained in one or more memory devices 120 (referred to as memory 120) functionally coupled to the compilation module 110. The document 122 can be retained in a filesystem within the memory 120. The document 122 can be a text file that defines the multiple keyphrases. As an example, but not limited hereto, the multiple keywords can include a combination of two or more of “hello analog,” “open the windows,” “Asterix stop” (e.g., where “Asterix” is a name of a device or robot), “lock the patio door,” “increase gas flow,” “increase temperature,” “shut down,” “turn on the lights,” or “lower the volume.”

As shown by the example “Asterix stop” above, keyphrases can identify an apparatus (or machine or device) and also can define a command for the apparatus. As such, to control multiple apparatuses using speech, the document 122 can define multiple keyphrases where each keyphrase has a particular structure that identifies an apparatus and defines a command for the apparatus. For example, each keyphrase can include a first string of characters defining an identifier corresponding to an apparatus and also can include a second string of characters defining a command. The first string of characters can precede the second string of characters. Thus, a command for an apparatus can be preceded by the name of the apparatus, e.g., “Alice, go to station 3” or “Bob, stop.” In some cases, in some keyphrases, the identifier is a collective identifier that corresponds to a group of apparatuses. In this way, a command to be implemented simultaneously or nearly simultaneously by the group of apparatuses can be detected in a single keyphrase within an utterance. For example, collective identifier can be “Blue Robots,” “Red Robots,” “Dispenser Robots,” or a similar tag or string of characters. In some cases, the group of apparatuses can encompass the multiple apparatuses. As such cases, the collective identifier can be “Everybody,” “Everyone,” “All,” or a similar tag or string of characters. Accordingly, some keyphrases can be of the following form, for example, “Everybody, stop” or “Blue robots, go to station 3”. Simply as an illustration, FIG. 1B is an example of the document 122 that includes a listing of keyphrases for a system of multiple apparatuses. The system includes three mobile robots of two different types. The three mobile robots are named “Alice,” “Bob,” and “Carol.” One type is referred to as Red and the other type referred to as Blue. The listing is keywords is not exhaustive and other keyphrases having the same structure can be included in the example document 122.

In order to prevent biases in the domain-specific language model that is generated, the compilation module 110 can generate one or more prefixes for each keyphrase of the multiple keyphrases that have been accessed. By incorporating prefixes into the domain-specific model, detection may not be biased to recognize a prefix of a keyphrase as the entire keyphrase. For example, in case the multiple keyphrases include “open the window” and “Asterix stop,” the compilation module 110 can generate the following prefixes: “open the” and “open,” and “Asterix.” If “Asterix” is the name of a robot and the “Asterix” prefix is not included in the domain-specific language model, detection may be biased to recognize “Asterix stop” even when simply “Asterix” or “Asterix start” has been uttered. Hence, by including prefixes in the domain-specific language, aspects of this disclosure can readily reduce the incidence of false positives during detection of keyphrases, thus avoiding potentially catastrophic instances of a false positive detection.

Accordingly, the compilation module 110 (via the composition component 210 (FIG. 2), for example) can generate a domain-specific finite state transducer (FST) representing one or more prefixes and each keyphrase of the multiple keyphrases in the keyphrase definition 122. Generating the domain-specific FST results in a domain-specific language model corresponding to the multiple keyphrases.

The domain-specific language model (e.g., a domain-specific statistical n-gram model) by itself may provide limited keyphrase recognition capability. A reason for such potential limitation is that keyphrase detection based on the domain-specific language model alone can result in interpreting any utterance as being one of the legal sentences defined by respective ones of the keyphrases in the keyphrase definition 122. Such an interpretation during keyphrase detection can yield a substantial false positive rate.

Accordingly, the compilation module 110 (via the merger component 220 (FIG. 2), for example) can merge the domain-specific language model with another language model that is based on an ordinary spoken natural language (such as, but not limited to, English or German). That other language model can be a wide-vocabulary statistical n-gram model that can recognize other utterances. Merging such models results in a keyphrase recognition model 114. In one example, the other language model can be a wide-vocabulary finite state transducer (FST) representing the ordinary spoken natural language. Thus, the keyphrase recognition model 114 can be a FST resulting from merging the domain-specific FST corresponding to the domain-specific model with the wide-vocabulary FST. The merged FST can assign first probabilities to sequences of words corresponding to respective keyphrases, and can assign second probabilities to sequences of words from ordinary speech where the second probabilities are similar to the wide-vocabulary FST for ordinary spoken natural language. The first probabilities can be higher than the second probabilities. Thus, the merged FST can assign a probability to a word in speech that is equal to the product of one of the second probabilities for that word and one of the first probabilities for the keyphrase containing that word. The compilation module 110 can retain the keyphrase recognition model 114 within the memory 120, as part of a group of models 126.

The keyphrase recognition model 114 can be a statistical n-gram model that has a weighting factor indicative of how likely it is that a speaker is speaking one of the keyphrases in the document 122, and how likely it is that the speaker is speaking ordinary speech. As such, the keyphrase recognition model 114 contemplates that a speaker either speaks in ordinary natural language (English, for example) or utters the keyphrases, with a relatively high but not overwhelmingly high probability of using the keyphrases. That is not to say that the speaker need not speak a keyphrase at a particular rate or during a particular portion of speech. Instead, such the probability of using keyphrases as is contemplated by the keyphrase recognition model 114 is an a priori probability that an utterance present is speech is a keyphrase. Such a probability is a configurable parameter, and in some cases, can range from about 0.01 to about 0.30.

As is illustrated in FIG. 1A, the computing system 100 can include a detection module 130 that can obtain the keyphrase recognition model 114, and can detect, based on applying the keyphrase recognition model 114 to speech, a particular keyphrase of the multiple keyphrases in the document 122. The detection module 130 can obtain the keyphrase recognition model 114 in several ways. In some cases, the detection module 130 can load the keyphrase recognition model 114 from the memory 120. In other cases, the detection module 130 can receive the keyphrase recognition model 114 from the compilation module 110 or a component functionally coupled thereto (such as an output/report component; not depicted in FIG. 1A). In other words, the detection module 130 may be deployed separately from the compilation module 110, such as being located in a completely different device; e.g., a first computing device of the computing system 100 contains the detection module 130 and a second computing device of the computing system 100 contains the compilation module 110. Regarding speech, the detection module 130 can receive an audio signal representative of speech or ambient audio, or both. The audio signal can be received by means of an audio input unit 150, for example. The audio signal can represent audible audio that is external to a computing device that hosts the detection module 130 and/or the audio input unit 150. The audio input unit 150 can include a microphone (e.g., a microelectromechanical (MEMS) microphone), analog-to-digital converter(s), amplifier(s), filter(s), and/or other circuitry for processing of audio. The microphone can receive the audible audio constituting an external audio signal representing the speech or the ambient audio, or both. The audio input unit 150 can send the external audio signal to the detection module 130 and/or another component included in the computing device.

As is illustrated in FIG. 2, the detection module 130 can include an ASR component 230 that can apply a keyphrase recognition model 114 to speech. The ASR component 230 can apply the keyphrase recognition model 114 by determining phonemes present within speech, and then determining, using the phonemes and the keyphrase recognition model 114, a most probable sequence of words (e.g., a phrase or sentence). The ASR component 230 can use a trained ML model to the determine the phonemes. The trained ML model can be a trained neural network, for example. In cases where the ASR component 230 processes ambient audio, the ASR component 230 may not determine phonemes and can thus identify that a pause in speech has occurred. The ASR component 230 can update state data 260 to indicate that a pause in speech for a predetermined period of time, e.g., a long pause, has occurred. Here, a long pause refers to a period of time that separates sentences in speech, and can be longer than another period of time that separates spoken words within a sentence. That period of time defining a long pause is a configurable quantity. Example of a long pause include 350 ms, 384 ms, and 400 ms.

The ASR component 230 can periodically determine a sequence of words by applying the keyphrase recognition model 114 to speech. Hence, the ASR component 230 can determine a sequence of words at consecutive time intervals spanning a same defined time period. The sequence of words that has been determined at a time interval corresponds to words that may have been spoken since a last long pause in speech. Accordingly, at each time interval, the ASR component 230 can update the words that may have been spoken since the last long pause. Each one of the time intervals, or the defined time period, can be referred to as a “tick.” Examples of the defined time period include 64 ms, 100 ms, 128 ms, 150 ms, 200 ms, 256 ms, and 300 ms. This disclosure is not limited in that respect, and longer or shorter ticks can be defined. It is noted that the long pause referred to hereinbefore can be defined as two or more ticks.

A sequence of words determined in a tick is referred to as a partial recognition. A final recognition refers to the immediately past sequence of words that has been determined before the ASR component 230 has identified a long pause. Accordingly, the ASR component 230 can determine a series of one or more partial recognitions before determining a final recognition. The ASR component 230 can update state data 260 within the memory 120 to indicate that a recognition is a final recognition. For example, the state data 260 can represent, among other things, a Boolean variable indicating if a recognition is final. The ASR component 230 can update the Boolean variable to “true” (or another value indicative of truth), in response to a recognition that is final.

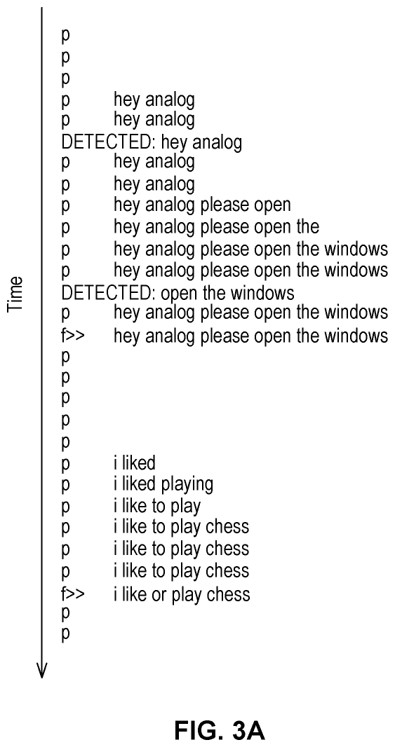

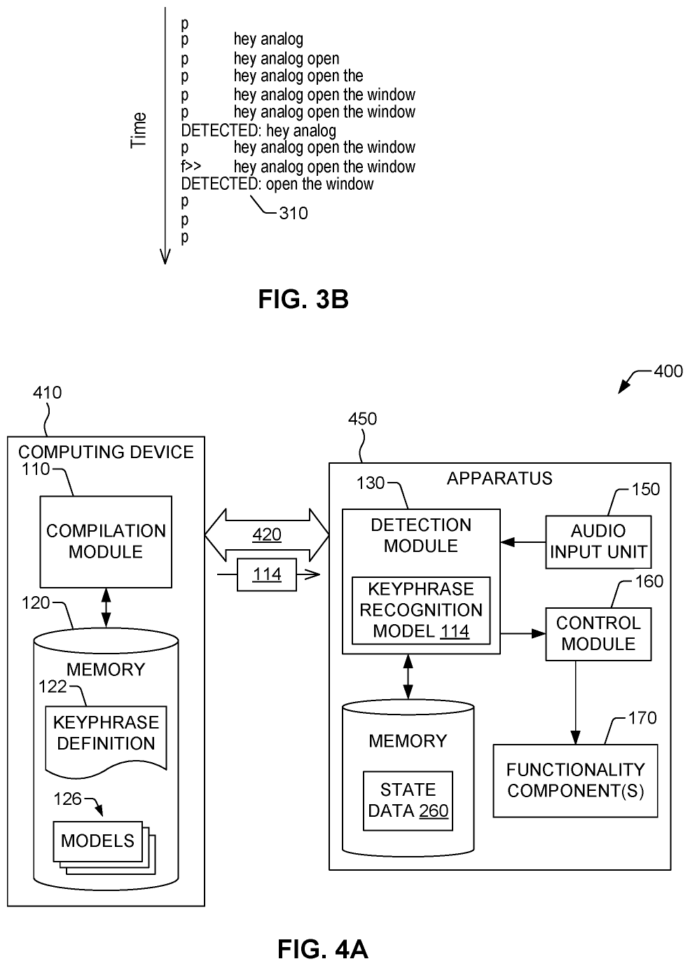

FIG. 3A illustrates an example of partial and final recognitions when a speaker utters “hey analog, please open the windows” and then “I like to play chess.” The “p” at the beginning of some lines indicates that the ASR component 230 emitted a partial recognition of a sequence of words received since the last final recognition. The “f>>” at the beginning of some lines indicates that the ASR component 230 indicated that such a recognition is a final recognition of a sequence of words followed by a pause. It is noted that the ASR component 230 may revise partial recognitions at later instants of time. For example, as is shown in FIG. 3A, the ASR component 230 can initially report “I liked playing” before changing to report “I like to play chess.” These types of changes can often occur as the probabilities change when more speech is processed and the overall probability changes based on the keyphrase recognition model 114 and the phonemes that are determined by the ASR component 230.

With further reference to FIG. 1A, the detection module 130 can use both partial recognitions and final recognitions in order to achieve responsive low-latency detection of keyphrases. Relying exclusively on a final recognition may hinder responsiveness, particularly in situations where the speech being processed spans a long time (e.g., a few to several seconds). Regardless of the type of recognition, the detection module 130 can detect a keyphrase in response to determining that a suffix of a sequence of words pertaining to the recognition includes the keyphrase. In some aspects, the detection module 130 can include a recognition component 240 (FIG. 2) that can determine presence or absence of a keyphrase in a suffix of the recognition. Determining presence of the keyphrase in the suffix indicates that the keyphrase has been recognized. Such a determination represents a preliminary detection of the keyphrase. For example, in case the ASR component 230 determines the sequence of words “what a fabulous day let's open the windows” in a first tick, the recognition component 240 can determine that the suffix corresponds to the keyphrase “open the windows,” and therefore a preliminary detection of “open the windows” occurs.

The multiple keyphrases defined in the document 122 can be configured with respective parameters (or another type of data) that indicate a desired latency to use in the detection of each keyphrase. Such parameters (or data) also can be defined in the document 122. For example, the document 122 can be a tab-separated value (TSV) file or comma-separated value (CSV) file, where each line has a field including a latency parameter (e.g., “4” indicating four ticks) and another field including a keyphrase (e.g., “hey analog”). In some cases, at least one keyphrase of the multiple keyphrases can be configured with respective parameters (or data) indicative of zero latency. In other cases, at least one of a second keyphrase of the multiple keyphrases can be configured with respective parameters (or data) indicative of non-zero latency.

A non-zero latency parameter (or datum) defines an intervening time period between a first preliminary detection of a keyphrase and a second preliminary detection of the keyphrase. The second preliminary detection can be referred to as confirmation detection, and is a subsequent recognition that occurs immediately after the intervening time period has elapsed. The intervening time period can thus be referred to as confirmation period, and that subsequent recognition can be referred to as confirmation detection. A preliminary detection of a particular keyphrase followed by a confirmation detection of the particular keyphrase yields a keyphrase detection of the particular keyphrase. The non-zero latency parameter can define the intervening time period as a multiple N_{L} of a tick. Here, N_{L} is a natural number equal to or greater than 1. Thus, a non-zero latency parameter can cause the detection module 130 to wait N_{L} ticks before recognizing the particular keyphrase at a time interval corresponding to the N_{L}+1 tick, and thus arriving at the confirmation detection. For example, the document 122 can configure a zero latency for a first keyphrase (e.g., “stop now”), a non-zero latency of one tick for a second keyphrase (e.g., “move forward”), and a non-zero latency of two ticks for a third keyphrase (e.g., “wake up”). Hence, not only can the detection module 130 flexibly detect different keyphrases, but it can detect the different keyphrases according to respective defined latencies. Such flexibility is an improvement over commonplace technology for keyphrase detection.

Because at each tick the ASR component 230 (FIG. 2) can update the sequence of words that has been recognized at the tick, the configuration of latency for keyphrases to be detected in speech can permit controlling a rate of false positives in the detection of a keyphrase. In scenarios where a low false-positive rate is desired (as it might be the case for wakeup phrases) N_{L} can be configured to 2, for example, causing the detection module 130 to wait two ticks for confirmation. In other scenarios where substantial low latency is desired and a greater rate of false positive may be tolerated, N_{L} can be set to zero. For example, zero latency can be configured for keyphrase indicative of a time-sensitive shutdown command.

Accordingly, to detect a particular keyphrase defined in the document 122, the detection module 130 can determine, using the keyphrase recognition model 114, a sequence of words within speech during a first time interval. The first time interval can span a tick (e.g., 128 ms). The detection module 130 can determine the sequence of words by means of the ASR component 230 (FIG. 2). The detection module 130 can then determine, via the recognition component 240 (FIG. 2), that a suffix of the sequence of words corresponds to the particular keyphrase. Determining such a suffix indicates that the particular keyword has been recognized and constitutes a preliminary detection. The detection module 130 can determine if the particular keyphrase is associated with a non-zero latency parameter. To that end, in some configurations, the detection module 130 can obtain a parameter indicative of latency for the particular keyphrase. That parameter can be obtained from the document 122. Determining that the particular keyphrase is associated with zero latency can cause the detection module 130 to configure the preliminary detection as a confirmation detection. The detection module 130 can include a confirmation component 250 (FIG. 2) that can generate confirmation data indicative of the particular keyphrase being present in the speech in the first time interval. In addition, the confirmation component 250 can update state data 260 (FIG. 2) to indicate that the particular keyphrase has been detected in the speech during the first time interval. The state data 260 can define a state variable for the particular keyphrase, and updating the state data can include updating the state variable to a value indicating that the particular keyphrase has been detected in the sequence of words associated with the first time interval.

Determining that the particular keyphrase is associated with a non-zero latency parameter can cause the detection module 130 to update state data 260 (FIG. 2) to indicate that the particular keyphrase has been recognized in the speech during the first time interval. The state data 260 can define a state variable for the particular keyphrase, and updating the state data can include updating the state variable to a first value indicating that the particular keyphrase has been recognized in the speech during the first time interval, but is not yet confirmed. The confirmation component 250 can update the state data 260 in such a fashion. Additionally, the non-zero latency parameter can cause the recognition component 240 to wait until a confirmation period has elapsed, while the ASR component 230 continues to recognize words spoken near a computing device that hosts the detection module 130.

In order to confirm the preliminary detection of the particular keyword that occurred in the first time interval, the detection module 130 can determine, using the keyphrase recognition model 114, respective second sequences of words within speech during each time interval in a series of consecutive second time intervals (e.g., consecutive ticks). The series of consecutive second time intervals begins immediately after the first time interval has elapsed and spans the confirmation period. The detection module 130 can determine the respective second sequences of words using the ASR component 230 (FIG. 2). In some cases, the detection module 130 can determine that a suffix of each one of the respective second sequences of words corresponds to the particular keyphrase that has been detected in the preliminary detection. In other words, the detection module 130 can determine consecutive subsequent recognitions of the particular keyphrase during the confirmation period. Accordingly, the detection module 130 can generate confirmation data indicative of the particular keyphrase being present in speech in a second time interval after the first time interval. In addition, the detection module 130 can update the state data 260 (FIG. 2) to indicate that the particular keyphrase has been detected, e.g., recognized and confirmed, after the confirmation period has elapsed. As is described herein, the state data can define a state variable for the particular keyphrase, and updating the state data 260 can include updating the state variable to a value indicating that the particular keyphrase has been detected in a second sequence of words associated with the second time interval. The confirmation component 250 (FIG. 2) can update the state data 260 in such a fashion.

In some cases, the ASR component 230 (FIG. 2) determines a final recognition of a sequence of words that has a particular keyphrase in a suffix of the sequence. In such cases, the detection module 130 can determine that the keyphrase has been detected, e.g., recognized and confirmed, regardless of latency associated with the particular keyphrase, FIG. 3B illustrates an example scenario where a N_{L}=4 is configured for both “hey analog” and “open the window.” A final recognition is determined prior to four ticks elapsing, and still a detection of “open the window” occurs (see “DETECTED” entry 310 in FIG. 3B).

Although aspects of the disclosure are illustrated with reference to keyphrases that define a language domain, the disclosure is not limited in that respect. The principles and practical applications of this disclosure can be extended to detection of any defined sequence of words, any phrase or sentence, that is sanctioned or otherwise accepted by a grammar, such as a context-free grammar. To that end, the computing system 100 (FIG. 1A) can include a high-speed parser component that can operate on suffixes of each recognition, to determine if a suffix is a defined phrase or sentence sanctioned by the grammar. Once the defined phrase or sentence is determined, the detection module 130 (via the recognition component 240, for example) can confirm the recognition of that defined phrase or sentence at a subsequent time interval (e.g., a tick) by determining if the defined phrase was contained within a partial or final recognition.

The detection of particular keyphrases has practical applications. For example, detecting a particular keyphrase can cause a computing device or another type of apparatus to perform a task or a group of tasks associated with the particular keyphrase. In some cases, in response to detecting the particular keyphrase, the detection module 130 can cause at least one functional component or a subsystem to execute one or more operations (e.g., control operations) associated with the particular keyphrase. Such operation(s) define a task. In one example, as is illustrated in FIG. 1A, the detection module 130 can direct a control module 160 to cause one or more functionality components 170 to perform a specific task in response to detecting a particular keyphrase (e.g., “open the windows” or “unlock the door”).

Depending on the functionality of an apparatus that includes the functionality component(s) 170, the functionality components 170 can include particular types of hardware or equipment. As an example, the functionality component(s) 170 can include a loudspeaker, a microphone, a camera device, a motorized brushing assembly, a robotic arm, sensor devices, power locks, motorized conveyor belts, or similar. In some cases, the functionality component(s) 170 include various hardware or equipment that can be separated into multiple subsystems. One or more of the multiple subsystems can include separate groups of functional elements. Simply as an illustration, in automotive applications, the multiple subsystems can include an in-vehicle infotainment subsystem, a temperature control subsystem, and a lighting subsystem. The in-vehicle infotainment subsystem can include a display device and associated components, a group of audio devices (loudspeakers, microphones, etc.), a radio tuner or a radio module including the radio tuner, or the like.

To cause the functionality component(s) 170 to perform the specific task, the control module 160 can then send an instruction to perform the specific task. The instruction can be formatted or otherwise configured to according to a control protocol for operation of equipment or other hardware that performs the task or is involved in performing the task. Depending on architecture of the functionality component(s) 170, the instruction can be formatted or otherwise configured according to a control protocol for the operation of a loudspeaker, an actuator, a switch, motors, a fan, a fluid pump, a vacuum pump, a current source device, an amplifier device, a combination thereof, or the like. The control protocol can include, for example, Modbus; Ethernet-based industrial protocol (e.g., Ethernet TCP/IP encapsulated with Modbus); controller area network (CAN) protocol; profibus protocol; and/or other types of fieldbus protocols.

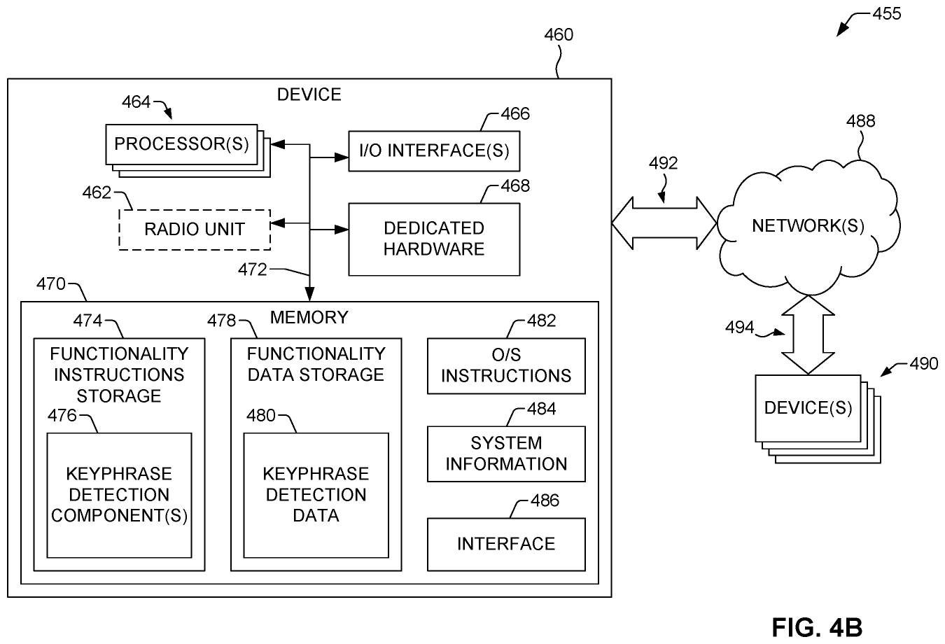

The example computing system 100 illustrated in FIG. 1A can be implemented in various ways. Simply for purposes of illustration, FIG. 4A is a block diagram of an example of a computing system where generation of a keyphrase recognition model is separate from application of the keyphrase recognition model to detection of keyphrases and related practical applications. An example of the practical applications is control of the operation of an apparatus. The example computing system 400 that is illustrated in FIG. 4A includes a computing device 410 that hosts the compilation module 110, and can generate the keyphrase recognition model 114 in accordance with aspects described herein.

The computing system 400 also includes an apparatus 450 that can host the detection module 130. The apparatus 450 can detect keyphrases by applying the keyphrase recognition model 114 to speech that may be received at the apparatus 450, in accordance with aspects described herein. The apparatus 450 can receive or otherwise obtain the keyphrase recognition model 114 from the computing device 410 or another device functionally coupled thereto (not depicted in FIG. 4A). In an example scenario, the apparatus 450 can receive the keyphrase recognition model 114 at factory during production of the apparatus 450. In another example scenario, the apparatus can receive the keyphrase recognition model 114 in the field, as part of a configuration stage (an initialization stage or an update stage, for example) of the apparatus 450. In some cases, the apparatus 450 can receive the keyphrase recognition model 114 via a communication architecture 420 that functionally couples the computing device 410 and the apparatus 450. The communication architecture 420 can permit wired communication and/or wireless communication. The apparatus 450 can perform one or more tasks in response to detecting a particular keyphrase or a sequence of particular keyphrases. The apparatus 450 (and other apparatuses in accordance with aspects of this disclosure) can include various computing resources (not all resources depicted in FIG. 4A) and also can be referred to as a computing device. Computing resources can include, for example, a combination of (A) one or multiple processors, (B) one or multiple memory devices, (C) one or multiple input/output interfaces, including network interfaces (wireless or otherwise); or similar resources. Similarly, a computing device embodies, or constitutes, an apparatus (or machine).

The disclosure is not limited to the apparatus 450 performing a task in response to detecting a particular keyphrase. The apparatus 450 can, in some cases, cause equipment that is external to the apparatus 450 to perform the task. To that end, the apparatus 450 can optionally be functionally coupled to equipment (not depicted in FIG. 4A) remotely located relative to the apparatus 450. For example, the apparatus 450 can be a server device for home automation and the equipment can include power locks distributed across doors and/or point of entry to a dwelling.

FIG. 4B illustrates an example of a system of devices that can provide various functionality of keyphrase detection and execution of control operation(s), in accordance with aspects of this disclosure. The example system 455 includes a device 460 and one or more remote devices 490. The type of components for keyphrase detection that the device 460 hosts can dictate the scope of keyphrase detection functionality that the device 460 provides. In some cases, the device 460 can host both the compilation module 110 and the detection module 130. Hence, the device 460 can generate a keyphrase recognition model for multiple keyphrases, and also can apply the keyphrase recognition model to speech in order to detect one or more particular keyphrases of the multiple keyphrases. In such cases, the device 460 also can host the control module 160 (FIG. 1A) and can thus cause hardware to perform a task in response to detection of a particular keyphrase. In other cases, the device 460 can host either the compilation module 110 or the detection module 130. For example, the device 460 can embody the computing device 410 or the apparatus 450. Accordingly, the device 460 can either generate the keyphrase recognition model or can apply the keyphrase recognition model to speech to detect a particular keyphrase and cause the execution of one or more control operations in accordance with aspects described herein. The device 460 in case it embodies the apparatus 450 also can host the control module 160. The disclosure is not limited in that respect and, in some cases, the device 460 can embody the computing device 410 and one of the remote device(s) 490 can embody the apparatus 450, or vice versa. In other words, the example system 455 can embody the example system 400 or other system of devices disclosed herein.

The device 460 can provide such functionality in response to execution of one or more software components retained within the device 460. Such component(s) can render the device 460 a particular machine for keyphrase detection, among other functional purposes that the device 460 may have. A software component can be embodied in or can comprise one or more processor-accessible instructions, e.g., processor-readable instructions and/or processor-executable instructions. In one scenario, at least a portion of the processor-accessible instructions can embody and/or can be executed to perform at least a part of one or more of the example methods described herein. The one or more processor-accessible instructions that embody a software component can be arranged into one or more program modules, for example, that can be compiled, linked, and/or executed at the device 460 or other computing devices. Generally, such program modules comprise computer code, routines, programs, objects, components, information structures (e.g., data structures and/or metadata structures), etc., that can perform particular tasks (e.g., one or more operations) in response to execution by one or more processors 464 integrated into the device 460.

The various example aspects of the disclosure can be operational with numerous other general purpose or special purpose computing system environments or configurations. Examples of well-known computing systems, environments, and/or configurations that can be suitable for implementation of various aspects of the disclosure in connection keyphrase detection can include personal computers; server computers; laptop devices; handheld computing devices, such as mobile tablets or electronic-book readers (e-readers); wearable computing devices; and multiprocessor systems. Additional examples can include programmable consumer electronics, network personal computers (PCs), minicomputers, mainframe computers, blade computers, programmable logic controllers, distributed computing environments that comprise any of the above systems or devices, and the like.

As is illustrated in FIG. 4B, the device 460 includes one or multiple processors 464, one or multiple input/output (I/O) interfaces 466, one or more memory devices 470 (referred to as memory 470), and a bus architecture 472 (referred to as bus 472) that functionally couples various functional elements of the device 460. The device 460 can include, optionally, a radio unit 462. The radio unit 462 can include one or more antennas and a communication processing device that can permit wireless communication between the device 460 and another device, such as one of the remote device(s) 490 and/or a remote sensor (not depicted in FIG. 4B). The communication processing device can process data according to defined protocols of one or more radio technologies. The data that is processed can be received in a wireless signal or can be generated by the device 460 for transmission in a wireless signal. The radio technologies can include, for example, 3G, Long Term Evolution (LTE), LTE-Advanced, 5G, IEEE 802.11, IEEE 802.16, Bluetooth, ZigBee, near-field communication (NFC), and the like.

The bus 472 can include at least one of a system bus, a memory bus, an address bus, or a message bus, and can permit the exchange of information (data and/or signaling) between the processor(s) 464, the I/O interface(s) 466, and/or the memory 470, or respective functional elements therein. In some cases, the bus 472 in conjunction with one or more internal programming interfaces 486 (also referred to as interface 486) can permit such exchange of information. In cases where the processor(s) 464 include multiple processors, the device 460 can utilize parallel computing.

The I/O interface(s) 466 can permit communication of information between the device 460 and an external device, such as another computing device. Such communication can include direct communication or indirect communication, such as the exchange of information between the device 460 and the external device via a network or elements thereof. As illustrated, the I/O interface(s) 466 can include one or more of network adapter(s), peripheral adapter(s), and display unit(s). Such adapter(s) can permit or facilitate connectivity between the external device and one or more of the processor(s) 464 or the memory 470. For example, the peripheral adapter(s) can include a group of ports, which can include at least one of parallel ports, serial ports, Ethernet ports, V.35 ports, or X.21 ports. In certain aspects, the parallel ports can comprise General Purpose Interface Bus (GPIB), IEEE-1284, while the serial ports can include Recommended Standard (RS)-232, V.11, Universal Serial Bus (USB), FireWire or IEEE-1394. In some cases, at least one of the I/O interface(s) can embody or can include the audio input unit 150 (FIG. 1A).

The I/O interface(s) 466 can include a network adapter that can functionally couple the device 460 to one or more remote devices 490 or sensors (not depicted in FIG. 4B) via a communication architecture. The communication architecture includes communication links 492, one or more networks 488, and communication links 494 that can permit or otherwise facilitate the exchange of information (e.g., traffic and/or signaling) between the device 460 and the one or more remote devices 490 or sensors. The communication links 492 can include upstream links (or uplinks (ULs)) and/or downstream links (or downlinks (DLs)). The communication links 494 also can include ULs and/or DLs. Each UL and DL included in the communication links 492 and communication links 494 can be embodied in or can include wireless links, wireline links (e.g., optic-fiber lines, coaxial cables, and/or twisted-pair lines), or a combination thereof. The network(s) 488 can include several types of network elements, including access points; router devices; switch devices; server devices; aggregator devices; bus architectures; a combination of the foregoing; or the like. The network elements can be assembled to form a local area network (LAN), a wide area network (WAN), and/or other networks (wireless or wired) having different footprints. One or more links in communication links 494, one or more links of the communication links 492, and at least one of the network(s) 488 form a communication pathway between the device 460 and at least one of the remote device(s) 490.

Such network coupling that is provided at least in part by the network adapter can thus be implemented in a wired environment, a wireless environment, or both. The information that is communicated by the network adapter can result from the implementation of one or more operations of a method in accordance with aspects of this disclosure. The I/O interface(s) 466 can include more than one network adapter in some cases. In an example configuration, a wireline adapter is included in the I/O interface(s) 466. Such a wireline adapter includes a network adapter that can process data and signal according to a communication protocol for wireline communication. Such a communication protocol can be one of TCP/IP, Ethernet, Ethernet/IP, Modbus, or Modbus TCP, for example. The wireline adapter also includes a peripheral adapter that permits functionally coupling the apparatus to another apparatus or an external device. The combination of such a wireline adapter and the radio unit 462 can form a communication unit in accordance with this disclosure.

In addition, or in some cases, depending on the architectural complexity and/or form factor the device 460, the I/O interface(s) 466 can include a user-device interface unit that can permit control of the operation of the device 460, or can permit conveying or revealing the operational conditions of the device 460. The user-device interface can be embodied in, or can include, a display unit. The display unit can include a display device that, in some cases, has touch-screen functionality. In addition, or in some cases, the display unit can include lights, such as light-emitting diodes, that can convey an operational state of the device 460.

The bus 472 can have at least one of several types of bus structures, depending on the architectural complexity and/or form factor the device 460. The bus structures can include a memory bus or a memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and the like.

The device 460 can include a variety of processor-readable media. Such a processor-readable media (e.g., computer-readable media can be any available media (transitory and non-transitory) that can be accessed by a processor or a computing device (or another type of apparatus) having the processor, or both. In one aspect, processor-readable media can comprise computer non-transitory storage media (or computer-readable non-transitory storage media) and communications media. Examples of processor-readable non-transitory storage media include any available media that can be accessed by the device 460, including both volatile media and non-volatile media, and removable and/or non-removable media. The memory 470 can include processor-readable media (e.g., computer-readable media or machine-readable media) in the form of volatile memory, such as random access memory (RAM), and/or non-volatile memory, such as read-only memory (ROM).

The memory 470 can include functionality instructions storage 474 and functionality data storage 478. The functionality instructions storage 474 can include computer-accessible instructions that, in response to execution (by at least one of the processor(s) 464, for example), can implement one or more of the functionalities of this disclosure in connection with keyphrase detection. The computer-accessible instructions can embody, or can include, one or more software components illustrated as keyphrase detection component(s) 476. Execution of at least one component of the keyphrase detection component(s) 476 can implement one or more of the methods described herein. Such execution can cause a processor (e.g., one of the processor(s) 464) that executes the at least one component to carry out at least a portion of the methods disclosed herein. In some cases, the keyphrase detection component(s) 476 can include the compilation module 110, the detection module 130, and the control module 160. In other cases, the keyphrase detection component(s) 476 can include the compilation module 110 or a combination of the detection module 130 and the control module 160. In some configurations, the device 460 can include a controller device that is part of the dedicated hardware 468. The dedicated hardware 468 can be specific to the functionality of the device 460, and can include the functionality component(s) 170 and/or other types of functionality components described herein. Such a controller device can embody, or can include, the control module 160 in some cases.

A processor of the processor(s) 464 that executes at least one of the keyphrase detection component(s) 476 can retrieve data from or retain data in one or more memory elements 480 in the functionality data storage 478 in order to operate in accordance with the functionality programmed or otherwise configured by the keyphrase detection component(s) 476. The one or more memory elements 480 may be referred to as keyphrase detection data 480. Such information can include at least one of code instructions, data structures, or similar. For instance, at least a portion of such data structures can be indicative of a keyphrase recognition model, documents defining keyphrases, state data, and/or data relevant to keyphrase detection in accordance with aspects of this disclosure.

The interface 486 (e.g., an application programming interface) can permit or facilitate communication of data between two or more components within the functionality instructions storage 474. The data that can be communicated by the interface 486 can result from implementation of one or more operations in a method of the disclosure. In some cases, one or more of the functionality instructions storage 474 or the functionality data storage 478 can be embodied in or can comprise removable/non-removable, and/or volatile/non-volatile computer storage media.

At least a portion of at least one of the keyphrase detection component(s) 476 or the keyphrase detection data 480 can program or otherwise configure one or more of the processors 464 to operate at least in accordance with the functionality described herein. One or more of the processor(s) 464 can execute at least one of the keyphrase detection component(s) 476, and also can use at least a portion of the data in the functionality data storage 478 in order to provide keyphrase detection in accordance with one or more aspects described herein. In some cases, the functionality instructions storage 474 can embody or can comprise a computer-readable non-transitory storage medium having computer-accessible instructions that, in response to execution, cause at least one processor (e.g., one or more of the processor(s) 464) to perform a group of operations comprising the operations or blocks described in connection with example methods disclosed herein.

In addition, the memory 470 can include processor-accessible instructions and information (e.g., data, metadata, and/or program code) that permit or facilitate the operation and/or administration (e.g., upgrades, software installation, any other configuration, or the like) of the device 460. Accordingly, in some cases, as is illustrated in FIG. 4B, the memory 470 can include a memory element 482 (labeled operating system (O/S) instructions 482) that contains one or more program modules that embody or include one or more operating systems, such as Windows operating system, Unix, Linux, Symbian, Android, Chromium, and substantially any OS suitable for mobile computing devices or tethered computing devices. In one aspect, the operational and/or architectural complexity of the device 460 can dictate a suitable O/S. The memory 470 also includes system information storage 484 having data, metadata, and/or program code that permits or facilitates the operation and/or administration of the device 460. Elements of the O/S instructions 482 and the system information storage 484 can be accessible or can be operated on by at least one of the processor(s) 464.

While the functionality instructions retained in the functionality instructions storage 474 and other executable program components, such as the O/S instructions 482, are illustrated herein as discrete blocks, such software components can reside at various times in different memory components of the device 460, and can be executed by at least one of the processor(s) 464.

The device 460 can include a power supply (not shown), which can power up components or functional elements within such devices. The power supply can be a rechargeable power supply, e.g., a rechargeable battery, and it can include one or more transformers to achieve a power level suitable for the operation of the device 460 and components, functional elements, and related circuitry therein. In some cases, the power supply can be attached to a conventional power grid to recharge and ensure that such devices can be operational. To that end, the power supply can include an I/O interface (e.g., one of the interface(s) 466) to connect to the conventional power grid. In addition, or in other cases, the power supply can include an energy conversion component, such as a solar panel, to provide additional or alternative power resources or autonomy for the device 460.

In some scenarios, the device 460 can operate in a networked environment by utilizing connections to one or more remote devices 490 and/or sensors (not depicted in FIG. 4B). As an illustration, a remote device can be a personal computer, a portable computer, a server, a router, a network computer, a peer device or other common network node, and so on. As mentioned, the device 460 can embody or can include a first apparatus in accordance with aspects described herein. Thus, simply as an illustration, the peer device can be a second apparatus also in accordance with aspects of this disclosure. The second apparatus can have same or similar functionality as the first apparatus—e.g., first apparatus and the second apparatus can both be welding robots or painting robots in an assembly line. In addition, or in some cases, besides including a peer device that is an apparatus, another remote device of the remote devices 490 can include the computing device 410 (FIG. 4A). As described herein, connections (physical and/or logical) between the device 460 and a remote device or sensor can be made via communication links 492, one or more networks 488, and communication links 494, which can comprise wired link(s) and/or wireless link(s) and several network elements (such as routers or switches, concentrators, servers, and the like) that form a LAN, a WAN, and/or other networks (wireless or wired) having different footprints.

One or more of the techniques disclosed herein can be practiced in distributed computing environments, such as grid-based environments, where tasks can be performed by remote processing devices (e.g., network servers) that are functionally coupled (e.g., communicatively linked or otherwise coupled) through a network having traffic and signaling pipes and related network elements. In a distributed computing environment, one or more software components (such as program modules) may be located in both the device 460 and at least one remote computing device.

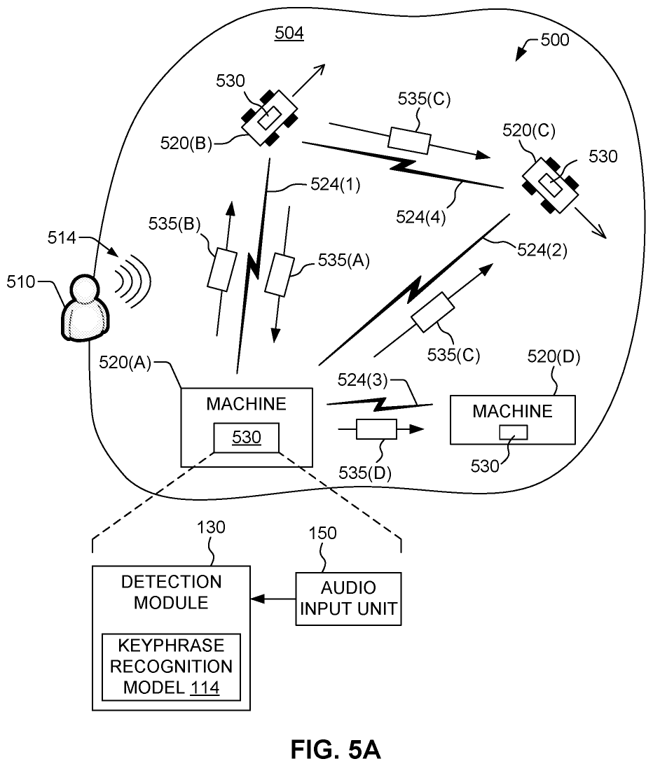

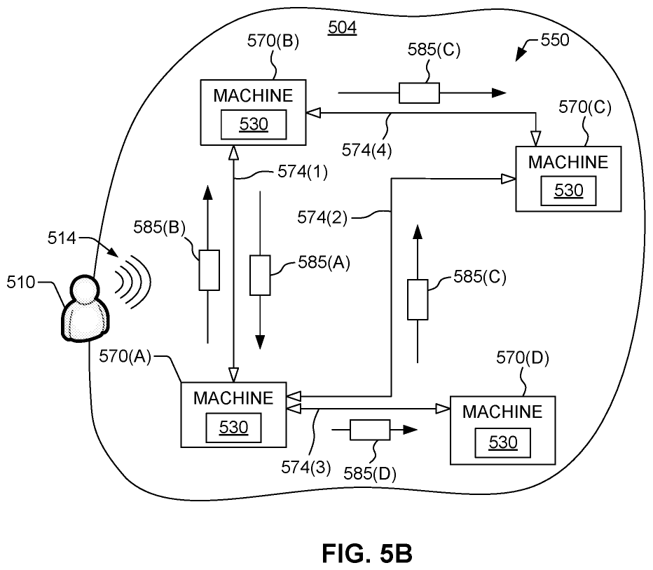

FIG. 5A is a block diagram of an example of a system that uses a distributed spoken language interface for voice control, in accordance with one or more aspects of this disclosure. The system 500 exemplified in FIG. 5A can include multiple apparatuses deployed within an area 504 that can be part of an industrial plant, a warehouse, an automated pharmacy, or similar. The multiple apparatuses can form a communication network. Thus, the multiple apparatuses can embody respective nodes in a peer-to-peer network or in a local area network, for example. Each of those networks can be configured as part of provisioning an apparatus in the example system 500. That is, in a scenario where an apparatus (e.g., a welding robot or a dispensing machine) is added to the example system 500 including the multiple apparatuses, the apparatus can be connected to the network in a dedicated provisioning operation or group of operations. The provisioning operation(s) also can include causing an update of the keyphrase definition 122 to define commands for the apparatus (e.g., the welding robot or dispensing machine) being added to the example system 500. The provisioning operations(s) can further include causing an update of the keyphrase recognition model 114 to incorporate one or more keyphrases corresponding to the apparatus being added. Each of such keyphrase(s) including an indicator or tag identifying the apparatus and respective commands. The apparatus that has been added or a computing device (not depicted in FIG. 5A) can cause the compilation module 110, for example, to update the keyphrase definition 122 and/or the keyphrase recognition model 114.

In some configurations, the multiple apparatuses can be of the same type and, thus, can form a homogenous system. In one example, each one of the multiple apparatuses can be a mobile robot, such as an autonomous guided vehicle (AGV). In another example, each one of the multiple apparatuses can be a stationary machine with defined functionality—e.g., a conveyor machine where speed of conveyance is configurable, a dispensing machine where dispense flow is configurable, or an industrial furnace where number of burner cells in operation is configurable. In other configurations, the multiple apparatuses can be of mixed types and, thus, can form a heterogeneous system. For example, at least one first apparatus of the multiple apparatuses can be a mobile robot, and at least one second apparatus of the multiple apparatuses can be a stationary machine. Simply as an illustration, as is shown in FIG. 5A, the multiple apparatuses include a stationary machine 520(A), a mobile robot 520(B), a mobile robot 520(C), and a stationary machine 520(D).

Regardless of its type, each apparatus of the multiple apparatuses can include a keyphrase detection interface 530 that can process speech in one or more natural languages. The keyphrase detection interface 530 can include the detection module 130 and the audio input unit 150, where the detection module 130 is configured with the keyphrase recognition model 114. In this way, the example system 500 includes a distributed spoken language interface formed by the combination of each keyphrase detection interface 530 in each one of the multiple apparatuses.

The distributed spoken language interface can permit detecting, in each apparatus of the multiple apparatuses within the example system 500, multiple keyphrases by applying the keyphrase recognition model 114 to speech. Each one of the multiple apparatuses can detect keyphrases via, at least in part, the detection module 130 that is present in the keyphrase detection interface 530 integrated into each apparatus. As is described herein in connection with FIG. 2, the detection module 130 includes the ASR component 230, the recognition component 240, and the confirmation component 250, and can detect keyphrases, based on speech received via the audio input unit 150, in accordance with aspects described herein. The multiple keyphrases correspond to the keyphrases that have been defined in the keyphrase definition 122. Accordingly, as is described herein, each keyphrase can include a first string of characters defining an identifier corresponding to an apparatus of the multiple apparatuses in the example system 500, and also can include a second string of characters defining a command that the apparatus can execute. The speech can be uttered by a subject 510 located within, or in proximity to, the area 504, and can include one or more utterances 514. In some cases, instead of being uttered by the subject 510, the speech can be supplied by a device (such as a loudspeaker or another audio output unit; not depicted in FIG. 5A) and can be a playback reproduction of speech uttered by a subject. As an alternative, the speech supplied by the device can be speech that has been generated synthetically (by an autonomous bot, for example).

Each apparatus in the example system 500 can detect keyphrases sequentially rather than simultaneously. Thus, as is described herein, as time progresses and speech is uttered, an apparatus in the example system 500 can detect a sequence of one or more particular keyphrases of the multiple keyphrases.

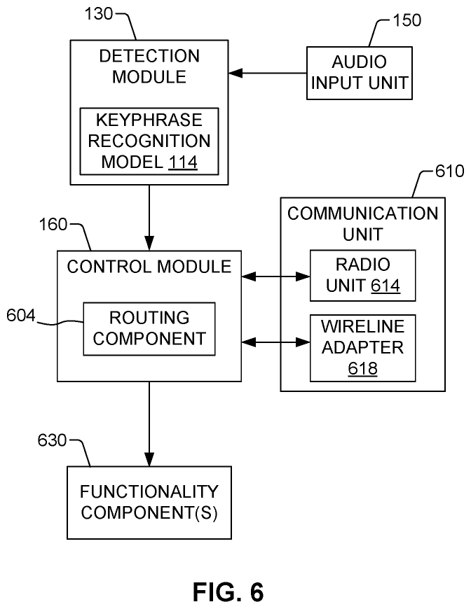

Detection of a keyphrase can cause an apparatus that has detected the keyphrase to respond to the detection of the keyphrase or to supply the keyphrase. In a situation where the keyphrase corresponds to the apparatus, the apparatus can respond to the detected keyphrase by executing a command defined by the keyphrase. As is illustrated in FIG. 6, each apparatus that forms part of the example system 500 includes the keyphrase detection interface 530 and also can include the control module 160. The control module 160 can include a routing component 604 that determines that the keyphrase corresponds either to the apparatus or to another apparatus. In response to the keyphrase corresponding to the apparatus, the routing component 604 can cause the apparatus to execute the command. To that end, the routing component 604 can cause one or more functionality components 630 to perform one or more operations (control operations or otherwise) corresponding to the command. The functionality component(s) 630 can be specific to the architecture and functionality of the apparatus. The functionality component(s) 630 can be part of the dedicate hardware 468 in some cases. Although not illustrated in FIG. 6, each apparatus that forms part of the example system 500 also includes at least one processor and at least one memory device. Indeed, as is described herein, each apparatus that is part of the example system 550 can include the structure of the device 460 described herein.

In a situation where the keyphrase corresponds to one or more other apparatuses in the example system 500, the keyphrase can be supplied to the one or more other apparatuses. To supply the keyphrase, the apparatus can communicate the keyphrase wirelessly based on an identifier that is present in the keyphrase. In some cases, the apparatus can unicast the keyphrase to a second apparatus, where the keyphrase corresponds to that second apparatus. Such a correspondence can be indicated by the identifier that is present in the keyphrase. For example, the identifier is indicative of a name, e.g., “Alice” or “Bob,” which identifies the second apparatus. In other cases, the apparatus can multicast the keyphrase to particular second apparatus(es) that belong to a defined category of apparatus in the example system 500. The identifier that is present in the keyphrase can indicate the defined category. For example, the identifier can be “Blue Robots,” “Red Robots,” “Dispenser Robots,” “Team Carrier,” or similar. In yet other cases, the apparatus can broadcast the keyphrase to the other apparatus(es) within the example system 500. The identifier that is present in the keyphrase can indicate that the keyphrase is to be broadcasted. For example, the identifier can be “Everybody,” “Everyone,” “All,” or similar tag or string of characters.

As is illustrated in FIG. 5A, the machine 520(A) can detect, based on the utterance(s) 514, a keyphrase for mobile robot 520(B) and can wirelessly send a message 535(B) to that mobile robot. The machine 520(A) can send the message 535(B) wirelessly to the mobile robot 520(B) via wireless links 524(1), according to defined protocols of a radio technology (e.g., Bluetooth or IEEE 802.11). The message 535(B) includes payload data defining the keyphrase. Additionally, the machine 520(A) can detect, based on the utterance(s) 514, a keyphrase for mobile robot 520(C) and can wirelessly send a message 535(C) to that mobile robot. The machine 520(A) can send the message 535(C) wirelessly to the mobile robot 520(C) via wireless links 524(2), according to the defined protocols of the radio technology. The message 535(C) includes payload data defining the keyphrase. Further, the machine 520(A) can detect, based on the utterance(s) 514, a keyphrase for machine 520(D) and can wirelessly send a message 535(D) to that machine. The machine 520(A) can send the message 535(D) wirelessly to the machine 520(D) via wireless links 524(3), according to the defined protocols of the radio technology or, in some cases, according to defined protocols for another radio technology. The message 535(D) includes payload data defining the keyphrase. Furthermore, the mobile robot 520(B) can detect, based on the utterance(s) 514, a keyphrase for mobile robot 520(C) and can wirelessly send a message 535(C) to that mobile robot. The mobile robot 520(B) can send the message 535(C) wirelessly to the mobile robot 520(C) via wireless links 524(4), according to the defined protocols of the radio technology or, in some cases, according to defined protocols for another radio technology. The message 535(C) includes payload data defining the keyphrase. Additionally, the mobile robot 520(B) can detect, based on the utterance(s) 514, a keyphrase for machine 520(A) and can wirelessly send a message 535(A) to that machine. The mobile robot 520(B) can send the message 535(A) wirelessly to the machine 520(A) via the wireless links 524(1), according to the defined protocols of the radio technology or, in some cases, according to defined protocols for another radio technology. The message 535(A) includes payload data defining the keyphrase.

Because mobile robot 520(C) and machine 520(D) are located further away from the subject 510, the mobile robot 520(C) and the machine 520(D) may not detect any keyphrase. In other situations where the intensity of the utterance(s) 514 is sufficient for sound to reach the mobile robot 520(C) and the machine 520(D), those apparatuses may each have an audio input unit 150 that has malfunctioned, and, as result, may be unable to detect any keyphrase based on utterance(s) 514. Yet, regardless of the reason for not being able to detect any keyphrase, the mobile robot 520(C) and the machine 520(D) still obtain respective keyphrases (and commands defined therein) from other apparatuses that have better signal-to-noise ratio for the utterance(s) 514 and properly functioning respective audio input units. Thus, despite different apparatuses having different noise profiles and related signal-to-noise ratio for a source of speech, and at least one of those apparatuses being unable to detect a keyphrase, the example system 500 still is reliable and robust. Such reliability and robustness are a clear improvement over existing technologies for controlling equipment using speech.

Although communication between apparatuses in the example system 500 (FIG. 5A) is described as being wireless, the disclosure is not limited to that type of communication. As is illustrated in FIG. 5B, an example system 550 can include multiple apparatuses that communicate with one another via wireline communication. The multiple apparatuses included in the example system 550 also be deployed within the area 504. The multiple apparatuses can form a communication network. Thus, the multiple apparatuses can embody respective nodes in a peer-to-peer network or in a local area network, for example. Each of those networks can be configured as part of provisioning an apparatus in the system 550. That is, in a scenario where an apparatus (e.g., a welding robot or a dispensing machine) is added to the example system 550, the apparatus can be connected to the network in a dedicated provisioning operation or group of operations. The provisioning operation(s) can be the same as the provisioning operation(s) described in connection with provisioning an apparatus to the example system 500.

In some configurations, the multiple apparatuses in the example system 550 can be of the same type and, thus, can form a homogenous system. In one example, each one of the multiple apparatuses can be a stationary machine with defined functionality—e.g., a conveyor machine where speed of conveyance is configurable, a dispensing machine where dispense flow is configurable, or an industrial furnace where number of burner cells in operation is configurable. In other configurations, the multiple apparatuses can be of mixed types and, thus, can form a heterogeneous system. For example, at least one first apparatus of the multiple apparatuses can be a mobile robot (which may be tethered to another equipment), and at least one second apparatus of the multiple apparatuses can be a stationary machine. Simply as an illustration, as is shown in FIG. 5B, the multiple apparatuses include a stationary machine 570(A), a stationary machine 570(B), a stationary machine 570(C), and a stationary machine 570(D).

Regardless of its type, each apparatus of the multiple apparatuses can include a keyphrase detection interface 530 that can process speech in one or more natural languages. As is described herein, the keyphrase detection interface 530 can include the detection module 130 and the audio input unit 150, where the detection module 130 is configured with the keyphrase recognition model 114. In this way, the example system 550 includes a distributed spoken language interface formed by the combination of each keyphrase detection interface 530 in each one of the multiple apparatuses.

As is described herein, the distributed spoken language interface can permit detecting, in each apparatus of the multiple apparatuses within the example system 550, multiple keyphrases by applying the keyphrase recognition model 114 to speech. Each one of the multiple apparatuses can detect keyphrases via, at least in part, the detection module 130 that is present in the keyphrase detection interface 530 integrated into each apparatus. As is discussed in connection with FIG. 2, the detection module 130 includes the ASR component 230, the recognition component 240, and the confirmation component 250, and can detect keyphrases, based on speech received via the audio input unit 150, in accordance with aspects described herein. The multiple keyphrases correspond to the keyphrases that have been defined in the keyphrase definition 122. Accordingly, as is described herein, each keyphrase can include a first string of characters defining an identifier corresponding to an apparatus of the multiple apparatuses in the example system 550, and also can include a second string of characters defining a command that the apparatus can execute. The speech can be uttered by the subject 510 located within, or in proximity to, the area 504, and can include one or more utterances 514. In some cases, instead of being uttered by the subject 510, the speech can be supplied by a device (such as a loudspeaker or another audio output unit; not depicted in FIG. 5B) and can be a playback reproduction of speech uttered by a subject. As an alternative, the speech supplied by the device can be speech that has been generated synthetically (by an autonomous bot, for example).

Each apparatus in the example system 500 can detect keyphrases sequentially rather than simultaneously. Thus, as is described herein, as time progresses and speech is uttered, an apparatus in the example system 550 can detect a sequence of one or more particular keyphrases of the multiple keyphrases.

Detection of a keyphrase can cause an apparatus that has detected the keyphrase to respond to the detection of the keyphrase or to supply the keyphrase. In a situation where the keyphrase corresponds to the apparatus, the apparatus can respond to the detected keyphrase by executing a command defined by the keyphrase. As is illustrated in FIG. 6, each apparatus that forms part of the example system 550 includes the keyphrase detection interface 530 and also can include the control module 160. The control module 160 can include a routing component 604 that can determine that the keyphrase corresponds either to the apparatus or to another apparatus. In response to the keyphrase corresponding to the apparatus, the routing component 604 can cause the apparatus to execute the command. To that end, the routing component 604 can cause one or more functionality components 630 to perform one or more operations (control operations or otherwise) corresponding to the command. The functionality components 630 can be specific to the architecture and functionality of the apparatus. The functionality component(s) 630 can be part of the dedicate hardware 468 in some cases. Although not illustrated in FIG. 6, each apparatus that forms part of the example system 550 also includes at least one processor and at least one memory device. Indeed, as is described herein, each apparatus that is part of the example system 550 can include the structure of the device 460 described herein.

In a situation where the keyphrase corresponds to one or more other apparatuses in the example system 550, the keyphrase can be supplied to the one or more other apparatuses. To supply the keyphrase, the apparatus can communicate the keyphrase based on an identifier that is present in the keyphrase. The keyphrase can be communicated via a wireline coupling between the apparatus and another apparatus that is the recipient of the keyphrase. In some cases, the apparatus can unicast the keyphrase to a second apparatus, where the keyphrase corresponds to that second apparatus. Such a correspondence can be indicated by the identifier that is present in the keyphrase. For example, the identifier is indicative of a name, e.g., “Alice” or “Bob,” which identifies the second apparatus. In other cases, the apparatus can multicast the keyphrase to particular second apparatus(es) that belong to a defined category of apparatus in the example system 500. The identifier that is present in the keyphrase can indicate the defined category. For example, the identifier can be “Blue Robots,” “Red Robots,” “Dispenser Robots,” “Team Carrier,” or similar. In yet other cases, the apparatus can broadcast the keyphrase to the other apparatus(es) within the example system 500. The identifier that is present in the keyphrase can indicate that the keyphrase is to be broadcasted. For example, the identifier can be “Everybody,” “Everyone,” “All,” or similar tag or string of characters.

As is illustrated in FIG. 5B, the machine 570(A) can detect, based on the utterance(s) 514, a keyphrase for the machine 570(B) and can send a message 585(B) to the machine 570(B). The machine 570(A) can send the message 585(B) via a wireline coupling 574(1). The message 585(B) includes payload data defining the keyphrase. In some cases, the wireline coupling 574(1) permits connecting the machine 570(A) and the machine 570(B) directly to one another. To that end, the wireline coupling 574(1) can be embodied in a wireline link to transport signals (analog signals, digital signals, or a combination thereof) indicative of data and/or signaling. In other cases, the wireline coupling 574(1) permits indirectly connecting the machine 570(A) and the machine 570(B). To that end, the wireline coupling 574(1) can be embodied in or can include several types of network elements, including router devices; switch devices; server devices; aggregator devices; bus architectures; a combination of the foregoing; or the like. One or more of the bus architectures can include an industrial bus architecture, such as an Ethernet-based industrial bus, a CAN bus, a Modbus, other types of fieldbus architectures, or the like.

Additionally, the machine 570(A) can detect, based on the utterance(s) 514, a keyphrase for the machine 570(C) and can send a message 585(C) to the machine 570(C). The machine 570(A) can send the message 585(C) via a wireline coupling 574(2). The message 585(C) includes payload data defining the keyphrase. In some cases, the wireline coupling 574(2) permits connecting the machine 570(A) and the machine 570(C) directly to one another. To that end, the wireline coupling 574(2) can be embodied in a wireline link to transport signals (analog signals, digital signals, or a combination thereof) indicative of data and/or signaling. In other cases, the wireline coupling 574(2) permits indirectly connecting the machine 570(A) and the machine 570(C). To that end, the wireline coupling 574(2) can be embodied in or can include several types of network elements, including router devices; switch devices; server devices; aggregator devices; bus architectures; a combination of the foregoing; or the like. One or more of the bus architectures can include an industrial bus architecture, such as an Ethernet-based industrial bus, a CAN bus, a Modbus, other types of fieldbus architectures, or the like.

Further, the machine 570(A) can detect, based on the utterance(s) 514, a keyphrase for the machine 570(D) and can send a message 585(D) to the machine 570(D). The message 585(D) includes payload data defining the keyphrase. The machine 570(A) can send the message 585(D) via a wireline coupling 574(3). In some cases, the wireline coupling 574(3) permits connecting the machine 570(A) and the machine 570(D) directly to one another. To that end, the wireline coupling 574(3) can be embodied in a wireline link to transport signals (analog signals, digital signals, or a combination thereof) indicative of data and/or signaling. In other cases, the wireline coupling 574(3) permits indirectly connecting the machine 570(A) and the machine 570(D). To that end, the wireline coupling 574(2) can be embodied in or can include several types of network elements, including router devices; switch devices; server devices; aggregator devices; bus architectures; a combination of the foregoing; or the like. One or more of the bus architectures can include an industrial bus architecture, such as an Ethernet-based industrial bus, a CAN bus, a Modbus, other types of fieldbus architectures, or the like.

Furthermore, the machine 570(B) can detect, based on the utterance(s) 514, a keyphrase for the machine 570(C) and can send a message 585(C) to the machine 570(C). The machine 570(B) can send the message 585(C) via a wireline coupling 574(4). The message 585(C) includes payload data defining the keyphrase. In some cases, the wireline coupling 574(4) permits connecting the machine 570(B) and the machine 570(C) directly to one another. To that end, the wireline coupling 574(4) can be embodied in a wireline link to transport signals (analog signals, digital signals, or a combination thereof) indicative of data and/or signaling. In other cases, the wireline coupling 574(4) permits indirectly connecting the machine 570(B) and the machine 570(C). To that end, the wireline coupling 574(4) can be embodied in or can include several types of network elements, including router devices; switch devices; server devices; aggregator devices; bus architectures; a combination of the foregoing; or the like. One or more of the bus architectures can include an industrial bus architecture, such as an Ethernet-based industrial bus, a CAN bus, a Modbus, other types of fieldbus architectures, or the like.

Additionally, the machine 570(B) can detect, based on the utterance(s) 514, a keyphrase for the machine 570(A) and can send a message 585(A) to the machine 570(A). The machine 570(A) can send the message 585(A) via the wireline coupling 574(1). The message 585(A) includes payload data defining the keyphrase.

Because the machine 570(C) and machine 570(D) are located further away from the subject 510, the machine 570(C) and the machine 570(D) may not detect any keyphrase. In other situations where the intensity of the utterance(s) 514 is sufficient for sound to reach the machine 570(C) and the machine 570(D), those machines may each have an audio input unit 150 that has malfunctioned, and, as result, may be unable to detect any keyphrase based on utterance(s) 514. Yet, regardless of the reason for not being able to detect any keyphrase, the machine 570(C) and the machine 570(D) still obtain respective keyphrases (and commands defined therein) from other apparatuses that have better signal-to-noise ratio for the utterance(s) 514 and properly functioning respective audio input units. Thus, despite different apparatuses having different noise profiles and related signal-to-noise ratio for a source of speech, and at least one of those apparatuses being unable to detect a keyphrase, the example system 550 still is reliable and robust. As mentioned, such reliability and robustness are a clear improvement over existing technologies for controlling equipment using speech.

It is noted that the example system 500 and the example system 550 can be deployed in respective sections of the area 504. Thus, in some cases, a larger system including the example system 500 and the example system 550 can be formed. That larger system can use a distributed spoken langue interface in accordance with aspects described herein, combining wireless communication and wireline communication of messages carrying respective keyphrases as is described herein. It is noted that the subject 510 can control, using speech, the multiple apparatuses present in the larger system.

As is illustrated in FIG. 6, at least to supply a keyphrase that has been detected, each apparatus that forms part of the example system 500 and the example system 550 can include the control module 160 and a communication unit 610. The communication unit 610 includes a radio unit 614 and a wireline adapter 618. In some cases, the communication unit 610 can exclude one of the radio unit 614 or the wireline adapter 618 in order to communicate data and signaling either wirelessly or via wireline communication. The control module 160 is functionally coupled with the keyphrase detection interface 530 and communication unit 610. Thus, the control module 160 is coupled with the radio unit 614 or the wireline adapter 618, or both. The radio unit 614 can have similar or same architecture and functionality as the radio unit 462 (FIG. 4B). The wireline adapter 618 includes a network adapter or another type of computing processing device (neither depicted in FIG. 6). The network adapter or that other computing processing device can process data and signal according to a communication protocol for wireline communication. Such a communication protocol can be one of TCP/IP, Ethernet, Ethernet/IP, Modbus, or Modbus TCP, for example. The wireline adapter 618 also includes a peripheral adapter (not depicted in FIG. 6) that permits functionally coupling the apparatus to another apparatus or an external device. As mentioned, the control module 160 can receive or otherwise obtain, via the routing component 604, for example, the keyphrase that has been detected. The routing component 604, using the keyphrase, can generate a message formatted according to a defined communication protocol to send and receive data and/or signaling. The defined communication protocol can be a communication protocol for wireless communication or a communication protocol for wireline communication. The message can include payload data indicative of the keyphrase. That is, the payload data can include first data indicative of an electronic address corresponding to a destination (or recipient) apparatus, such as mobile robot 530(B), and also second data indicative of the command defined by the keyphrase. The control module 160, via the routing component 604, for example, can use the identifier present in the keyword to determine the electronic address. To that end, the routing component 604 can map the identifier to a profile data of the destination apparatus, where the profile data can be included in a profile retained in a memory device integrated into the apparatus.

The control module 160, via the routing component 604, for example, can cause or otherwise direct the radio unit 614 to send the message wirelessly to the destination apparatus. The radio unit 614 can send the message wirelessly according to defined protocols of a radio technology (e.g., Bluetooth, ZigBee, NFC, or IEEE 802.11).

Keyphrases can define respective commands for a particular apparatus. As is described herein, a portion of the keyphrases can identify the particular apparatus. Regardless of how the particular apparatus receives a keyphrase from another apparatus, the particular apparatus can execute an operation in response to the command defined by the keyphrase. Because more than one apparatus in the example system 500 (and also in the example system 550) can communicate the keyphrase to the particular apparatus, the reliability of voice control in accordance with aspects of this disclosure can be superior to existing technologies for voice control. Additionally, the air interface used to communicate the keyphrase is unaffected by sound attenuation. Accordingly, not only can the particular apparatus be controlled using spoken commands, but the particular apparatus need not operate in a quiet environment. Indeed, the particular apparatus can operate in an environment having substantive ambient noise (e.g., ambient noise level in a range from 65 dB to 90 dB) and/or the particular apparatus itself can generate noise.

Reliability of the example system 500 and the example system 550 in terms of false positive rates and false negative rates can be improved by evaluating whether or not one or more execution criteria are satisfied prior executing a command defined by a keyphrase received by an apparatus in the system 500. In some aspects of this disclosure, a false positive occurs when an apparatus determines that a command that that was not uttered is detected by the detection module 130. Additionally, a false negative occurs when an apparatus misses a command that was actually uttered by a subject or provided a device. In some cases, a single execution criterion can be evaluated. The execution criterion can be a defined threshold number of a same keyphrase having been received during eh defined time interval; that is a threshold number of times the same command has been received during the defined time interval. An apparatus can accumulate, via the control module 160, the keyphrases received during a defined time interval. Examples of the defined time interval include 200 ms, 250 ms, and 300 ms. The apparatus, via the control module 160, can then determine a number of a same keyphrase that has been received during the defined time interval. The apparatus, via the control module 160, can determine if the execution criterion is satisfied. In a situation wherein the execution criterion is satisfied—e.g., the number of received same keyphrases is equal to or exceed the threshold number—the control module 160 can cause the apparatus to execute the one or more control operations.

Simply as an illustration, in an example scenario where the example system 500 includes the stationary machine 520(A), the mobile robot 520(B), the mobile robot 520(C), and the stationary machine 520(D), each one of those apparatuses can include an execution criterion defined as two of the same keyphrases having been received within 50 ms. Hence, in one instance, the mobile robot 520(C) can receive the same keyphrase twice within 50 ms, e.g., one time from the machine 520(A), via the message 535(C), and one other time from the mobile robot 530(B), via the message 535(C). As a result, the mobile robot 520(C) can execute the command defined by that same keyphrase. That is, the mobile robot 520(C) can perform one or more control operations corresponding to the command.

To illustrate improvements arising from using such an execution criterion, in such an example scenario, it can be considered that each robot independently have a 10% chance of missing a keyphrase (e.g., a false negative) and a 0.1% chance of misunderstanding non-commands as a keyphrase (e.g., a false positive). The likelihood of three of the robots missing a keyphrase so that the example system 500 misses the keyphrase would be much less than 10%, while the likelihood that two apparatuses simultaneously made the same wrong interpretation of a false positive would also be much less than 0.1%. Thus, false positive rates and false negative rates can be simultaneously improved using the distributed spoken language interface of this disclosure.

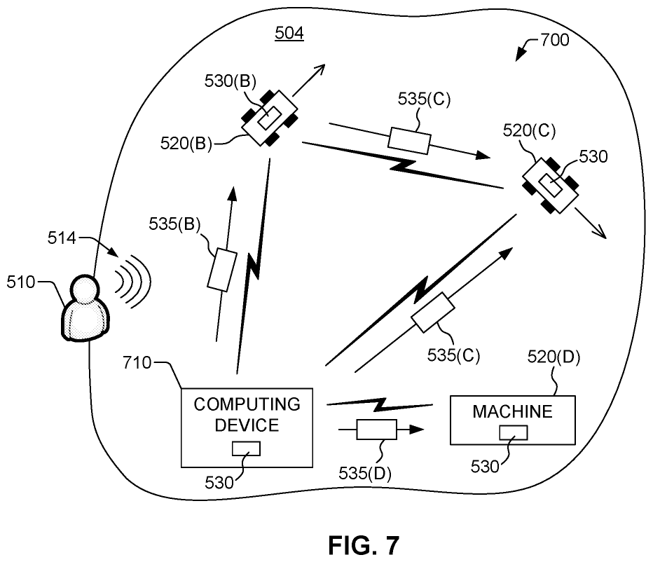

In some cases, one or more computing devices can be added to the multiple apparatuses that form a system having a distributed spoken language interface for voice control, in accordance with aspects of this disclosure. FIG. 7 is a block diagram of an example system 700 that uses a distributed spoken language interface for voice control and includes a computing device 710. The computing device 710 includes a keyphrase detection interface 530 that forms part of the distributed spoken language interface. The computing device 710 can process speech (e.g., utterance(s) 514) and can detect keyphrases, as is described herein. The computing device 710 also can supply, e.g., communicate, one or more detected keyphrases, as is described herein.

In some cases, each of the apparatuses in a system controlled using speech in accordance with aspects of this disclosure can have the structure and functionality of the device 460 (FIG. 4B), where the dedicated hardware 468 is specific to the apparatus, and the functionality instructions storage can include the control module 160 having the routing component 604 (FIG. 6). Such a system can be, or can include, the example system 500, the example system 550, or the example system 700. The keyphrase detection data 480 also can include apparatuses profiles, data indicative of detected keyphrases, execution criteria, electronic addresses, name of the apparatus, data defining mappings between an identifier in a keyphrase and one or more electronic addressed, and the like.

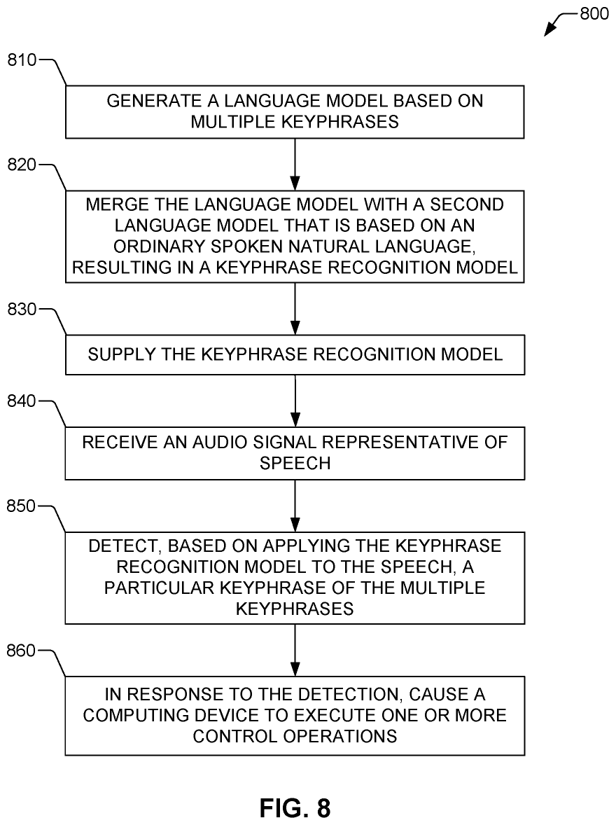

Example methods that can be implemented in accordance with this disclosure can be better appreciated with reference to FIGS. 8-11. For purposes of simplicity of explanation, example methods disclosed herein are presented and described as a series of acts. The example methods are not limited by the order of the acts, as some acts may occur in different orders and/or concurrently with other acts from that shown and described herein. In some cases, one or more example methods disclosed herein can alternatively be represented as a series of interrelated states or events, such as in a state diagram depicting a state machine. In addition, or in other cases, interaction diagram(s) (or process flow(s)) may represent methods in accordance with aspects of this disclosure when different entities enact different portions of the methodologies. It is noted that not all illustrated acts may be required to implement a described example method in accordance with this disclosure. It is also noted that two or more of the disclosed example methods can be implemented in combination with each other, to accomplish one or more functionalities described herein.

Methods disclosed herein can be stored on an article of manufacture in order to permit or facilitate transporting and transferring such methodologies to computers or other types of information processing apparatuses for execution, and thus implementation, by one or more processors, individually or in combination, or for storage in a memory device or another type of computer-readable storage device. In one example, one or more processors that enact a method or combination of methods described herein can be utilized to execute program code retained in a memory device, or any processor-readable or machine-readable storage device or non-transitory media, in order to implement method(s) described herein. The program code, when configured in processor-executable form and executed by the one or more processors, causes the implementation or performance of the various acts in the method(s) described herein. The program code thus provides a processor-executable or machine-executable framework to enact the method(s) described herein. Accordingly, in some cases, each block of the flowchart illustrations and/or combinations of blocks in the flowchart illustrations can be implemented in response to execution of the program code.

FIG. 8 illustrates an example of a method for detecting keyphrases, in accordance with one or more aspects of this disclosure. The example method 800 illustrated in FIG. 8 can be implemented by a single computing device or a system of computing devices. To that end, each computing device includes various types of computing resources, such as a combination of one or multiple processors, one or multiple memory devices, one or multiple network interfaces (wireless or otherwise), or similar resources. Additionally, in some cases, a computing device involved in the implementation of the method 800 can include functional elements or components that can provide particular functionality. Those other elements or components can include, for example, a loudspeaker, a microphone, a camera device, a motorized brushing assembly, a robotic arm, a fan, a fluid pump, a vacuum pump, a motor, a heating element, power locks, or similar.

In some cases, a system of computing devices implements the example method 800. The system of computing devices can include the compilation module 110 and the detection module 130, among other modules and/or components. The system of computing devices also can include the audio input unit 150.

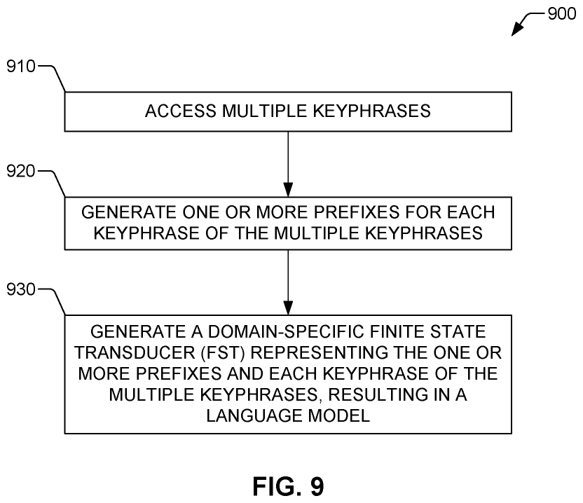

At block 810, the system of computing devices (via the compilation module 110, for example) can generate a language model based on multiple keyphrases. The language model is a domain-specific language model and, as is described herein, can be a statistical n-gram model. The multiple keyphrases define a domain. The language model can be generated by implementing the example method illustrated in FIG. 9.

At block 820, the system of computing devices (via the compilation module 110, for example) can merge the language model with a second language model that is based on an ordinary spoken natural language. The second language model can correspond to a wide-vocabulary finite state transducer (FST) representing the ordinary spoken natural language. Examples of the natural language include English, German, Spanish, or Portuguese. Merging such models results a keyphrase recognition model. Merging the language model with the second language model can include configuring first probabilities to sequences of words corresponding to respective keyphrases, and assigning second probabilities to sequences of words from ordinary speech where the second probabilities are similar to the wide-vocabulary FST for ordinary spoken natural language. The first probabilities can be higher than the second probabilities. Thus, the merged FST can assign a probability to a word as a product of one of the second probabilities for that word and one of the first probabilities for the keyphrase containing that word.

At block 830, the system of computing devices can supply the keyphrase recognition model. To that end, in some cases, a first computing device of the system of computing devices can send the keyphrase recognition model to a second computing device of the system of computing devices. In one example, the first computing device is or includes the computing device 410 (FIG. 4A) and the second computing device is or includes the apparatus 450 (FIG. 4A).

At block 840, the system of computing devices can receive an audio signal representative of speech. The audio signal can be received by means of the audio input unit 150, for example. The audio signal can be external to one of the computing devices within the system, and in some cases, can be representative of both the speech and ambient audio.

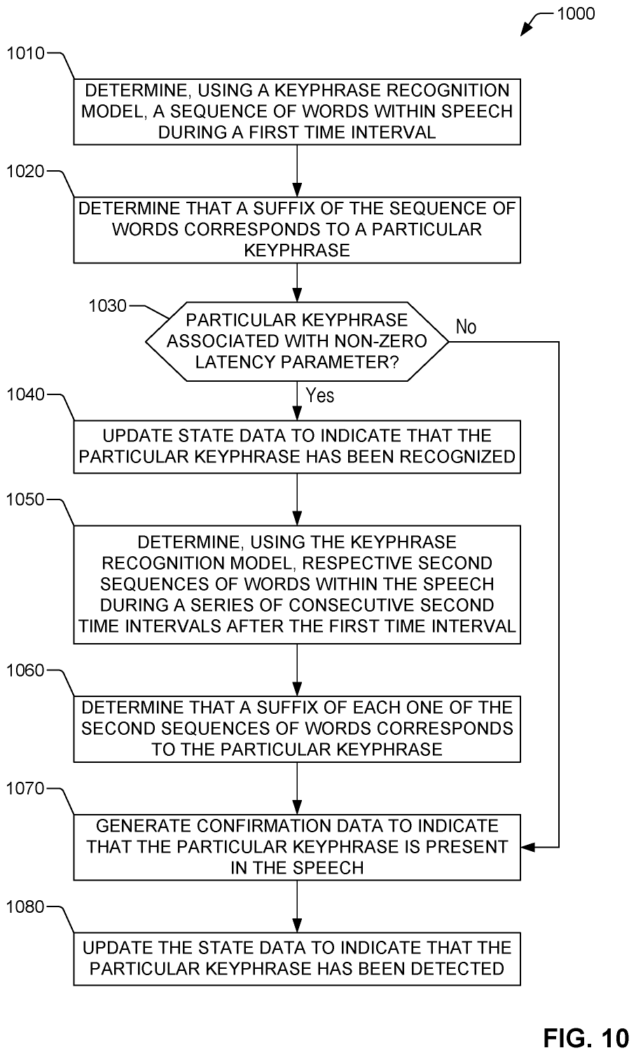

At block 850, the system of computing devices (via the detection module 130, for example) can detect, based on applying the keyphrase recognition model to the speech, a particular keyphrase of the multiple keyphrases. An approach to detecting the particular keyphrase in such a fashion is illustrated in the example method illustrated in FIG. 10. Accordingly, the system of computing devices can implement the example method 1000 (FIG. 10) to detect, based on applying the keyphrase recognition model to the speech, a particular keyphrase of the multiple keyphrases.

At block 860, in response to detecting the particular keyphrase, the system of computing devices (via the detection module 130 or the control module 160, for example) can cause at least one functional component of the computing device (or another type of apparatus) to execute one or more control operations.

FIG. 9 illustrates an example of a method for generating a keyphrase recognition model, in accordance with one or more aspects of this disclosure. The example method 900 illustrated in FIG. 9 can be implemented by a single computing device or a system of computing devices. To that end, as is described herein, each computing device includes various types of computing resources, such as a combination of one or multiple processors, one or multiple memory devices, one or multiple network interfaces (wireless or otherwise), or similar resources.

In some cases, a computing device implements the example method 900. The computing device can include the compilation module 110, among other modules and/or components. As such, the computing device can implement the example method 900 by means of the compilation module 110. The computing device can be part of the system of computing devices that can implement the example method 800 (FIG. 8), in some cases.

At block 910, the computing device can access multiple keyphrases—e.g., a combination of two or more of “hello analog,” “open the windows,” “Asterix stop,” “lock the patio door,” “change gas flow,” “increase temperature,” “shut down,” “turn on the lights,” or “lower the volume.” Accessing the multiple keyphrases can include reading a document retained within a filesystem of the computing device. The document can be a text file that defines the multiple keyphrases. An example of the document is the document 122 (FIG. 1A).

At block 920, the computing device can generate one or more prefixes for each keyphrase of the multiple keyphrases. For example, in case the multiple keyphrases include “open the window” and “Asterix stop,” the computing device can generate the following prefixes: “open the” and “open,” and “Asterix.”

At block 930, the computing device can generate a domain-specific finite state transducer (FST) representing the one or more prefixes and each keyphrase of the multiple keyphrases. Generating the domain-specific FST results in a language model corresponding to the multiple keyphrases.

FIG. 10 illustrates an example of a method for detecting a keyphrase, in accordance with one or more aspects of this disclosure. The example method 1000 illustrated in FIG. 10 can be implemented by a single computing device or a system of computing devices. To that end, as is described herein, each computing device includes various types of computing resources, such as a combination of one or multiple processors, one or multiple memory devices, one or multiple network interfaces (wireless or otherwise), or similar resources. Additionally, in some cases, a computing device involved in the implementation of the method 1000 can include functional elements that can provide particular functionality. Those other elements can include, for example, a loudspeaker, a microphone, a camera device, a motorized brushing assembly, a robotic arm, a fan, a fluid pump, a vacuum pump, a motor, a heating element, power locks, or similar. The functional elements can embody or can be part of the functionality component(s) 170.

In some cases, a computing device implements the example method 1000. The computing device can include the detection module 130 (FIG. 2, for example) among other modules and/or components. As such, the computing device can implement the example method 1000 by means of the detection module 130 (FIG. 2, for example). The computing device can be part of the system of computing devices that can implement the example method 800 (FIG. 8), in some cases.

At block 1010, the computing device can determine, using a keyphrase recognition model, a sequence of words within speech during a first time interval. The sequence of words can be determined by means of an ASR component, for example. The ASR component (e.g., ASR component 230 (FIG. 2)) can be integrated into the detection module 130, for example. The first time interval can span a defined time period (e.g., 128 ms). As is described herein, the defined time period can be referred to as a tick, simply for the sake of nomenclature.

At block 1020, the computing device can determine that a suffix of the sequence of words corresponds to the particular keyphrase. Determining such a suffix indicates that the particular keyword has been recognized. For example, the keyphrase can be “lock the patio door” and, thus, the suffix is “lock the patio door.”

At block 1030, the computing device can determine if the particular keyphrase is associated with a non-zero latency parameter. As is described herein, the non-zero latency parameter can define an intervening time period between an initial recognition of the keyphrase and confirmation recognition of the keyphrase. The confirmation recognition is a subsequent recognition that occurs immediately after the intervening time period has elapsed. The non-zero latency parameter can define the intervening time period as a multiple of a tick. Thus, a non-zero latency parameter causes the computing device to wait a number of ticks before recognizing the particular keyphrase at a time interval corresponding to an immediately consecutive tick, and thus arriving at the confirmation recognition.

In response to a positive determination at block 1030, the computing device can take the “Yes” branch. Thus, the flow of the example method 1000 proceeds to block 1040, where the computing device can update state data to indicate that the particular keyphrase has been recognized in the speech during the first time interval. The state data can define a state variable for the particular keyphrase, and updating the state data can include updating the state variable to a first value indicating that the particular keyphrase has been recognized in the speech during the first time interval.

At block 1050, the computing device can determine, using the keyphrase recognition model, respective second sequences of words within the speech during time intervals of a series of consecutive second time intervals (e.g., consecutive ticks) after the first time interval. The respective second sequences of words also can be determined by means of the ASR component (e.g., ASR component 230 (FIG. 2)) relied upon to determine the sequence of words at block 1010. Each one of the second time intervals in the series also can span the defined time period (e.g., 128 ms). The series of consecutive second time intervals can begin immediately after the first time interval elapsed and spans an intervening time period. In some cases, the series can have a single second time interval beginning immediately after the first time interval elapses. The intervening time period can correspond to a multiple of the defined time period (e.g., N_{L}>1). In other words, the series of consecutive second time intervals can be a series of consecutive ticks subsequent to the first tick associated with the initial recognition of the particular keyphrase at the first time interval. A terminal tick in the series is delayed relative to the first tick by the intervening time period. As mentioned, the intervening time period can be referred to as a confirmation period.

At block 1060, the computing device can determine that a suffix of each one of the respective second sequences of words corresponds to the particular keyphrase. In other words, the computing device can determine one or more subsequent recognitions of the particular keyphrase during the confirmation period, until the confirmation period elapses. Accordingly, at block 1070, the computing device can generate confirmation data indicative of the particular keyphrase being present in the speech in a terminal time interval of the series of consecutive second time intervals.

At block 1080, the computing device can update the state data to indicate that the particular keyphrase has been detected in the terminal time interval. As is described herein, the state data can define a state variable for the particular keyphrase, and updating the state data can include updating the state variable to a first value indicating that the particular keyphrase has been detected in the second sequence of words associated with the second time interval.

In response to a negative determination at block 1030, the computing device can take the “No” branch. Accordingly, the flow of the example method 1000 proceeds to block 1070 and then to block 1080.

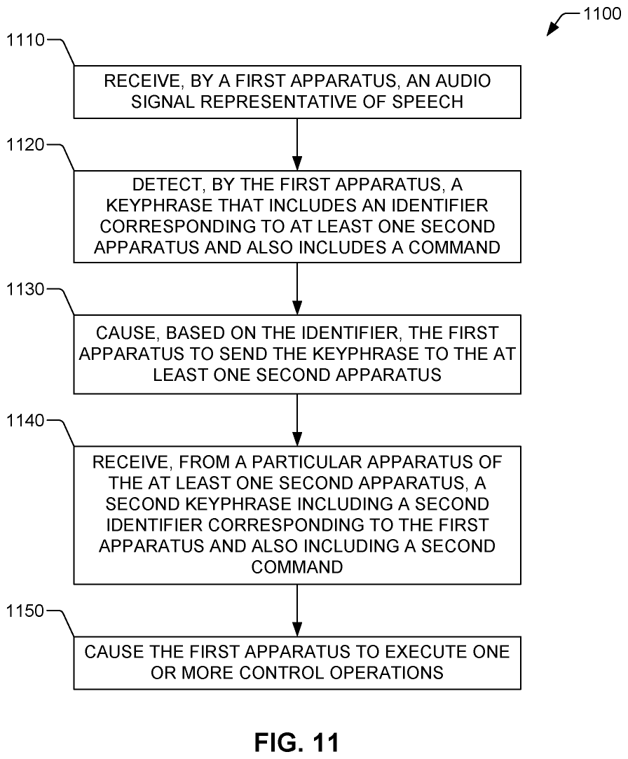

FIG. 11 is a flowchart of an example of a method for controlling, using speech, the operation of an apparatus in a system having a distributed spoken language interface, in accordance with one or more aspects of this disclosure. The example method 1100 illustrated in FIG. 11 can be implemented by a system of apparatuses. To that end, as is described herein, each apparatus includes various types of computing resources, such as a combination of one or multiple processors, one or multiple memory devices, one or multiple network interfaces (wireless or otherwise), or similar resources.

At block 1110, a first apparatus of the system can receive an audio signal representative of speech. The first apparatus includes the audio input unit 150, and can receive the audio signal by means of the audio input unit 150. In some cases, the audio signal can be representative of both the speech and ambient audio.

At block 1120, the first apparatus can detect a keyphrase. The keyphrase includes a first string of characters defining an identifier corresponding to at least one second apparatus in the system, and also includes a second string of characters defining command. The keyphrase can be detected based on applying a keyphrase recognition model to the speech. The keyphrase recognition model can be, for example, the keyphrase recognition model 114. An approach to detecting the keyphrase in such a fashion is illustrated in the example method shown in FIG. 10 and described hereinbelow.

At block 1130, the first apparatus can cause, based on the identifier, a communication unit of the first apparatus to send the keyphrase to the at least one second apparatus. The communication unit can include a radio unit and/or a wireline adapter (e.g., a combination of a network adapter and a peripheral adapter) in accordance with aspects described herein. In some cases, the communication unit is the communication unit 610 (FIG. 6), and thus, the radio unit is the radio unit 614 and the wireline adapter is the wireline adapter 618. As is described herein, in some cases, based on the identifier, the radio unit can send the keyphrase wirelessly in unicast modality, multicast modality, or broadcast modality. In other cases, based on the identifier, the communication unit can send the keyphrase in a wireline communication, in unicast modality, multicast modality, or broadcast modality.

At block 1140, the first apparatus can receive, from a particular apparatus of the at least one second apparatus, a second keyphrase. The second keyphrase includes a first string of characters defining a second identifier corresponding to at least one second apparatus in the system, and also includes a second string of characters defining a second command. The first apparatus can receive the second keyphrase wirelessly or in a wireline communication. To that end, the first apparatus includes the communication unit 610 described herein.

At block 1150, the first apparatus can cause at least one functional component of the first apparatus to execute one or more control operations. Such at least one functional component of the first apparatus can include one or more of the functionality component(s) 630 (or, in some cases, the functionality component(s) 170).

Numerous other embodiments emerge from the foregoing detailed description and annexed drawings. For instance, an Example 1 of the numerous other embodiments includes a method comprising: receiving, by a first apparatus, an audio signal representative of speech; detecting, by the first apparatus, based on applying a keyphrase recognition model to the speech, a particular keyphrase of multiple keyphrases, wherein the keyphrase recognition model is based on the multiple keyphrases, and wherein the particular keyphrase comprises a first string of characters defining an identifier corresponding to at least one second apparatus and further comprises a second string of characters defining a command; and causing, based on the identifier, the first apparatus to send the particular keyphrase to the at least one second apparatus.

An Example 2 of the numerous other embodiments includes the method of Example 1, wherein the identifier corresponds to one of an individual apparatus or a group of apparatuses, and wherein the first string of characters precedes the second string of characters.

An Example 3 of the numerous other embodiments includes the method of Example 1, further comprising: receiving, from a particular apparatus of the at least one second apparatus, a second particular keyphrase of the multiple keyphrases, wherein the second particular keyphrase comprises a first string of characters defining a second identifier corresponding to the first apparatus and further comprises a second string of characters defining a second command; and causing the first apparatus to execute one or more control operations corresponding to the second command.

An Example 4 of the numerous other embodiments includes the method of Example 3, wherein the second particular keyphrase is received within a defined time interval, the method further comprising determining, based on the defined time interval, that an execution criterion is satisfied prior to the causing the first apparatus to execute the one or more control operations.

Example 5. The method of example 4, wherein the determining that the execution criterion is satisfied comprises determining that multiple particular keyphrases has been received within the defined time interval, each one of the multiple particular keyphrases comprising the second identifier and the second command.

An Example 6 of the numerous other embodiments includes the method of Example 1, further comprising: receiving, by the first apparatus, a second audio signal representative of second speech; detecting, by the first apparatus, based on applying the keyphrase recognition model to the second speech, a second particular keyphrase of the multiple keyphrases, wherein the second particular keyphrase comprises a first string of characters defining a second identifier corresponding to the first apparatus and further comprises a second string of characters defining a second command; and sending, based on the second identifier, the second particular keyphrase to at least one component of the first apparatus.

An Example 7 of the numerous other embodiments includes the method of Example 6, further comprising, in response to the detecting the second particular keyphrase, causing the first apparatus to execute one or more control operations.

An Example 8 of the numerous other embodiments includes the method of Example 1, wherein the detecting comprises: determining, using the keyphrase recognition model, a sequence of words within the speech during a first time interval; and determining that a suffix of the sequence of words corresponds to the particular keyphrase.

An Example 9 of the numerous other embodiments includes the method of Example 8, wherein the detecting further comprises generating confirmation data indicative of the particular keyphrase being present in the speech in the first time interval.

An Example 10 of the numerous other embodiments includes the method of Example 9, further comprising updating a state variable for the particular keyphrase to a value indicating that the particular keyphrase has been detected in the sequence of words associated with the first time interval.

An Example 11 of the numerous other embodiments includes the method of Example 8, further comprising, determining that the particular keyphrase is associated with a non-zero latency parameter; and updating a state variable for the particular keyphrase to a first value indicating that the particular keyphrase has been recognized in the speech during the first time interval.

An Example 12 of the numerous other embodiments includes the method of Example 11, wherein the detecting further comprises, determining, using the keyphrase recognition model, a second sequence of words within the speech during a second time interval after the first time interval; and determining that a second suffix of the second sequence of words corresponds to the particular keyphrase.

An Example 13 of the numerous other embodiments includes the method of Example 12, wherein the detecting further comprises generating confirmation data indicative of the particular keyphrase being present in the speech in the second time interval.

An Example 14 of the numerous other embodiments includes the method of Example 13, further comprising updating the state variable for the particular keyphrase to a second value indicating that the particular keyphrase has been detected in the second sequence of words associated with the second time interval.

An Example 15 of the numerous other embodiments includes the method of Example 12, wherein the first time interval spans a defined time period and the second time interval spans the defined time period, and wherein the second time interval begins immediately after the first time interval elapses.

An Example 16 of the numerous other embodiments includes the method of Example 12, wherein the first time interval spans a defined time period and the second time interval spans the defined time period, and wherein the second time interval begins after the first time interval elapsed and ends when a confirmation period elapses.

An Example 17 of the numerous other embodiments includes the method of Example 16, wherein the confirmation period corresponds to a multiple of the defined time period.

An Example 18 of the numerous other embodiments includes a system comprising: multiple apparatuses including a first apparatus comprising: an audio input unit; a communication unit; at least one processor; and at least one memory device storing processor-executable instructions that, in response to being executed by the at least one processor, cause the first apparatus at least to: receive, via the audio input unit, an audio signal representative of speech; detect, based on applying a keyphrase recognition model to the speech, a particular keyphrase, wherein the keyphrase recognition model is based on multiple keyphrases, and wherein the particular keyphrase comprises a first string of characters defining an identifier corresponding to at least one second apparatus of the multiple apparatuses and further comprises a second string of characters defining a command; and cause, based on the identifier, the communication unit to send the particular keyphrase to the at least one second apparatus.

An Example 19 of the numerous other embodiments includes the system of Example 18, wherein the identifier corresponds to a particular identifier of an individual apparatus or a group of apparatuses, and wherein the first string of characters precedes the second string of characters.

An Example 20 of the numerous other embodiments includes the system of Example 18, wherein the first apparatus and the at least one second apparatus are nodes in a peer-to-peer network.

An Example 21 of the numerous other embodiments includes the system of Example 18, wherein each one of the first apparatus and the at least one second apparatus is a mobile robot.

An Example 22 of the numerous other embodiments includes the system of Example 18, wherein each one of the first apparatus and the at least one second apparatus is a stationary machine.

An Example 23 of the numerous other embodiments includes the system of Example 18, wherein a particular apparatus of the at least one second apparatus is a mobile robot, and wherein a second particular apparatus of the at least one second apparatus is a stationary machine.

An Example 24 of the numerous other embodiments includes an apparatus comprising: an audio input unit; a communication unit; at least one processor; and at least one memory device storing processor-executable instructions that, in response to being executed by the at least one processor, cause the apparatus at least to: receive, via the audio input unit, an audio signal representative of speech; detect, based on applying a keyphrase recognition model to the speech, a particular keyphrase, wherein the keyphrase recognition model is based on multiple keyphrases, and wherein the particular keyphrase comprises a first string of characters defining an identifier corresponding to at least one second apparatus further comprises a second string of characters defining a command; and cause, based on the identifier, the communication unit to send the particular keyphrase to the at least one second apparatus.

An Example 25 of the numerous other embodiments includes the apparatus of Example 24, wherein the identifier corresponds to one of an individual apparatus or a group of apparatuses, and wherein the first string of characters precedes the second string of characters.

An Example 26 of the numerous other embodiments includes the apparatus of Example 24, wherein the processor-executable instructions, in further response to being executed by the at least one processor, further cause the apparatus to: receive, from a particular apparatus of the at least one second apparatus, a second particular keyphrase comprising a first string of characters defining a second identifier corresponding to the apparatus and further comprising a second string of characters defining a second command; and cause execution of one or more control operations corresponding to the second command.

An Example 27 of the numerous other embodiments includes the apparatus of Example 26, wherein the second particular keyphrase is received within a defined time interval, the processor-executable instructions, in further response to being executed by the at least one processor, further cause the apparatus to determine, based on the defined time interval, that an execution criterion is satisfied prior to causing execution of the one or more control operations corresponding to the second command.

An Example 28 of the numerous other embodiments includes the apparatus of Example 27, wherein determining, based on the defined time interval, that the execution criterion is satisfied comprises determining that multiple second particular keyphrases have been received within the defined time interval, each one of the multiple second particular keyphrases comprising the second identifier and the second command.

An Example 29 of the numerous other embodiments includes the apparatus of Example 24, wherein the processor-executable instructions, in further response to being executed by the at least one processor, further cause the apparatus to: receive, via the audio input unit, a second audio signal representative of second speech; detect, based on applying the keyphrase recognition model to the second speech, a second particular keyphrase of the multiple keyphrases, wherein the second particular keyphrase comprises a first string of characters defining a second identifier corresponding to the apparatus and further comprises a second string of characters defining a second command; and send, based on the second identifier, the second particular keyphrase to at least one component of the apparatus.

An Example 30 of the numerous other embodiments includes the apparatus of Example 29, wherein the processor-executable instructions, in further response to being executed by the at least one processor, further cause the apparatus to cause execution of one or more second control operations in response to detecting the second particular keyphrase.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, a special purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “interface,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and doesn't necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general purpose computer, a special purpose computer, or another type of programmable data processing apparatus to produce a machine, such that the instructions which execute on the computer or other programmable data processing apparatus create a means for implementing the functionality of disclosed herein.

The terminology “article of manufacture” as used herein is intended to encompass a computer program or other type of machine instructions stored in and accessible from any processor-accessible (e.g., computer-readable) device, carrier, or media. For example, processor-accessible (e.g., computer readable) media can include to magnetic storage devices (e.g., hard drive disk, floppy disk, magnetic strips, or similar), optical discs (e.g., compact disc (CD), digital versatile disc (DVD), blu-ray disc (BD), or similar), smart cards, flash memory devices (e.g., card, stick, key drive, or similar), and other types of memory devices.

What has been described above includes examples of one or more aspects of the disclosure. It is, of course, not possible to describe every conceivable combination of components or methodologies for purposes of describing these examples, and it can be recognized that many further combinations and permutations of the present aspects are possible. Accordingly, the aspects disclosed and/or claimed herein are intended to embrace all such alterations, modifications and variations that fall within the spirit and scope of the detailed description and the appended claims. Furthermore, to the extent that one or more of the terms “includes,” “including,” “has,” “have,” or “having” is used in either the detailed description or the claims, such term is intended to be inclusive in a manner similar to the term “comprising” as “comprising” is interpreted when employed as a transitional word in a claim.

What is claimed is:

1. A method, comprising:
receiving, by a first apparatus, an audio signal representative of speech;
detecting, by the first apparatus, based on applying a keyphrase recognition model to the speech, a particular keyphrase of multiple keyphrases, wherein the keyphrase recognition model is based on the multiple keyphrases, and wherein the particular keyphrase comprises a first string of characters defining an identifier corresponding to at least one second apparatus and further comprises a second string of characters defining a command; and
causing, based on the identifier, the first apparatus to send the particular keyphrase to the at least one second apparatus.

2. The method of claim 1, wherein the identifier corresponds to one of an individual apparatus or a group of apparatuses, and wherein the first string of characters precedes the second string of characters.

3. The method of claim 1, further comprising:
receiving, from a particular apparatus of the at least one second apparatus, a second particular keyphrase of the multiple keyphrases, wherein the second particular keyphrase comprises a first string of characters defining a second identifier corresponding to the first apparatus and further comprises a second string of characters defining a second command; and
causing the first apparatus to execute one or more control operations corresponding to the second command.

4. The method of claim 3, wherein the second particular keyphrase is received within a defined time interval, the method further comprising determining, based on the defined time interval, that an execution criterion is satisfied prior to the causing the first apparatus to execute the one or more control operations.

5. The method of claim 4, wherein the determining that the execution criterion is satisfied comprises determining that multiple particular keyphrases has been received within the defined time interval, each one of the multiple particular keyphrases comprising the second identifier and the second command.

6. The method of claim 1, further comprising:
receiving, by the first apparatus, a second audio signal representative of second speech;
detecting, by the first apparatus, based on applying the keyphrase recognition model to the second speech, a second particular keyphrase of the multiple keyphrases, wherein the second particular keyphrase comprises a first string of characters defining a second identifier corresponding to the first apparatus and further comprises a second string of characters defining a second command; and
sending, based on the second identifier, the second particular keyphrase to at least one component of the first apparatus.

7. The method of claim 6, further comprising, in response to the detecting the second particular keyphrase, causing the first apparatus to execute one or more control operations.

8. The method of claim 1, wherein the detecting comprises:
determining, using the keyphrase recognition model, a sequence of words within the speech during a first time interval; and
determining that a suffix of the sequence of words corresponds to the particular keyphrase.

9. A system, comprising:
multiple apparatuses including a first apparatus comprising:
an audio input unit;
a communication unit;
at least one processor; and
at least one memory device storing processor-executable instructions that, in response to being executed by the at least one processor, cause the first apparatus at least to:
receive, via the audio input unit, an audio signal representative of speech;
detect, based on applying a keyphrase recognition model to the speech, a particular keyphrase, wherein the keyphrase recognition model is based on multiple keyphrases, and wherein the particular keyphrase comprises a first string of characters defining an identifier corresponding to at least one second apparatus of the multiple apparatuses and further comprises a second string of characters defining a command; and
cause, based on the identifier, the communication unit to send the particular keyphrase to the at least one second apparatus.

10. The system of claim 9, wherein the identifier corresponds to a particular identifier of an individual apparatus or a group of apparatuses, and wherein the first string of characters precedes the second string of characters.

11. The system of claim 9, wherein the first apparatus and the at least one second apparatus are nodes in a peer-to-peer network.

12. The system of claim 9, wherein each one of the first apparatus and the at least one second apparatus is a mobile robot.

13. The system of claim 9, wherein each one of the first apparatus and the at least one second apparatus is a stationary machine.

14. The system of claim 9, wherein a particular apparatus of the at least one second apparatus is a mobile robot, and wherein a second particular apparatus of the at least one second apparatus is a stationary machine.

15. An apparatus comprising:
an audio input unit;
a communication unit;
at least one processor; and
at least one memory device storing processor-executable instructions that, in response to being executed by the at least one processor, cause the apparatus at least to:
receive, via the audio input unit, an audio signal representative of speech;
detect, based on applying a keyphrase recognition model to the speech, a particular keyphrase, wherein the keyphrase recognition model is based on multiple keyphrases, and wherein the particular keyphrase comprises a first string of characters defining an identifier corresponding to at least one second apparatus further comprises a second string of characters defining a command; and
cause, based on the identifier, the communication unit to send the particular keyphrase to the at least one second apparatus.

16. The apparatus of claim 15, wherein the identifier corresponds to one of an individual apparatus or a group of apparatuses, and wherein the first string of characters precedes the second string of characters.

17. The apparatus of claim 15, wherein the processor-executable instructions, in further response to being executed by the at least one processor, further cause the apparatus to:
receive, from a particular apparatus of the at least one second apparatus, a second particular keyphrase comprising a first string of characters defining a second identifier corresponding to the apparatus and further comprising a second string of characters defining a second command; and
cause execution of one or more control operations corresponding to the second command.

18. The apparatus of claim 17, wherein the second particular keyphrase is received within a defined time interval, the processor-executable instructions, in further response to being executed by the at least one processor, further cause the apparatus to determine, based on the defined time interval, that an execution criterion is satisfied prior to causing execution of the one or more control operations corresponding to the second command.

19. The apparatus of claim 18, wherein determining, based on the defined time interval, that the execution criterion is satisfied comprises determining that multiple second particular keyphrases have been received within the defined time interval, each one of the multiple second particular keyphrases comprising the second identifier and the second command.

20. The apparatus of claim 15, wherein the processor-executable instructions, in further response to being executed by the at least one processor, further cause the apparatus to:
receive, via the audio input unit, a second audio signal representative of second speech;
detect, based on applying the keyphrase recognition model to the second speech, a second particular keyphrase of the multiple keyphrases, wherein the second particular keyphrase comprises a first string of characters defining a second identifier corresponding to the apparatus and further comprises a second string of characters defining a second command; and
send, based on the second identifier, the second particular keyphrase to at least one component of the apparatus.

21. The apparatus of claim 20, wherein the processor-executable instructions, in further response to being executed by the at least one processor, further cause the apparatus to cause execution of one or more second control operations in response to detecting the second particular keyphrase.
